(19) United States
(12) Patent Application Publication
(10) Pub. No.: US 2014/0069240 A1
(43) Pub. Date: Mar. 13, 2014

(54) Flexible Transmission Device for Tool Extensions and the Like

(71) Applicants: Jae E. Dauvin, Redvers (CA); George A. Dauvin, Redvers (CA)

(72) Inventors: Jae E. Dauvin, Redvers (CA); George A. Dauvin, Redvers (CA)

(21) Appl. No.: 14/024,893

(22) Filed: Sep. 12, 2013

(30) Foreign Application Priority Data
Sep. 13, 2012 (CA) 2789488

(51) Int. Cl. B25B 23/00

(52) U.S. Cl. CPC B25B 23/0021
USPC 81/177.6; 464/111

(57) ABSTRACT

Flexible transmission devices, for example for use a tool extensions for effecting rotation of fasteners that are difficult or impossible to access straight on using the normal output of a tool. A series of internal couplers are connected together end-to-end by constrained ball and socket joints that allow tilting between the axes of the couplers while constraining relative rotation of the couplers about said axes. The internal couplers form a flexible shaft inside an outer casing formed by a series of collar-shaped links joined in adjacent pairs by a single-axis pivot connection, each positioned to coincide with a respective one of the ball and socket joints.

### CROSS REFERENCE TO RELATED APPLICATIONS

This application claims benefit under 35 U.S.C. 119(a) of Canadian Patent Application Serial No. 2,789,488, filed Sep. 13, 2012, the entirety of which is incorporated herein by reference.

### FIELD OF THE INVENTION

The present invention relates generally to flexible transmission devices, useful for example as flexible extensions for torque transmitting tools, and more particularly to a device featuring internal couplings fitted axially together in series through male and female ends forming constrained ball and socket joints that allow relative pivoting between the axes of the couplings while employing radial projections and matching slots to transmit torque from one coupling to the next, and an external casing formed by a series of collar-shaped links with single-axis pivotal connection between adjacent links.

### BACKGROUND OF THE INVENTION

A known problem in the use of torque transmitting tools such as socket wrenches, impact guns, screwdrivers, etc. is that conventional tool designs require a notable amount of axial space by which the tool can approach the fastener (nut, bolt, fastener) in a straight on manner along the fastener's rotational axis.

One solution previously proposed in U.S. Patent Application Publication No. 2011/0303053, the entirety of which is incorporated herein by reference, is to assemble a flexible tool extension in the form of a series of couplers having mating male/female ends, where the male end of one coupler fits into the female end of a next coupler in a manner allowing relative pivoting between the couplers in directions shifting the couplers into and out of axial alignment, while cooperative hexagonal shapes of the male and female ends operate to transmit torque from one coupler to the next under driven rotation of an adapter at the input end of the extension by the tool.

However, one potential problem with the design is that repeated use in higher torque applications, for example use of an impact gun compared to lower torque hand tool applications, the hexagonal facets of the male end of the couplers may tend to ‘round off’, reducing or voiding the torque transmission functionality between the mating couplers.

Other solutions include the use of a universal joint connected between an impact wrench or other socket driver and the socket, as disclosed for example in U.S. Pat. Nos. 6,869,366, 7,153,214 and 6,152,826. These U-joints employ a ball-and-socket-like configuration, where a spherically contoured male end of one piece is received in a spherical cavity of a female end of another piece, and protrusions/projections and channels/slots on opposing ones of the male and female ends cooperate to constrain the joint against relative rotation between the pieces about their longitudinal axes while the spherically contoured ball-and-socket-like configuration allows tilting of the axes relative to one another in different directions. This way, the angle between the pieces can vary accordingly to the desired angle of the tool action, while rotation is transmitted from one piece to the next to drive the socket through driver. However, the disclosed use of a single U-joint between the driver and the socket provides a relative short extension of the tool and allows for only a single angular bend between the driver and the socket, thus limiting the attainable amount of overall flexibility between the drive and the socket. The two U-joint pieces also require installation of an additional retention piece between them to maintain engagement of the ball in the socket.

Other examples of flexible shaft designs can also be found in U.S. Pat. Nos. 5,572,913, 733,181, 890,336, and 897,349, U.S. Patent Application Publications 2007/0259723, 2009/0182416 and 2011/0197719, French Patent Application 2681919, and Japanese Patent Application 2002-39149.

Some of the aforementioned prior art flexible shaft references employ an outer casing having a series of pivotally connected links which contain a series of internal components defining movable joints between them to form the flexible shaft by allowing pivoting between the internal components while transferring rotation from one to the next.

Other prior art concerning flexible-link casing assemblies for various uses includes U.S. Pat. Nos. 4,739,801, 4,944,687 and 5,839,476, European Patent 1213522, and European Patent Application Publication 2096729.

Applicant has developed a unique flexible shaft solution that is believed to provide improved functionality and performance over prior art flexible shaft and tool extension solutions.

### SUMMARY OF THE INVENTION

According to a first aspect of the invention there is provided a tool extension comprising:

a plurality of intermediate couplers each having a body with a longitudinal axis and male and female ends pointing in opposing directions along said longitudinal axis, the male and female ends having opposing ones of at least one slot having an axial length and a radial depth relative to the longitudinal axis and at least one projection having a radial extent relative to the longitudinal axis, and the male end of each intermediate coupler being insertable into the hollow interior of the female end of another of the intermediate couplers in an orientation sliding each projection into a respective slot in a fit that allows relative pivoting of the longitudinal axes of the intermediate couplers into and out of alignment with one another;

a drive end adapter having a first end configured for engagement by a drive element of a tool, and a second end configured for engagement with one of either the male end or the female end of one of the intermediate couplers; and

a working end adapter having a first end having a first end configured for providing an output action under use of the tool, and a second end configured for engagement with the other of either the male end or the female end of another of the intermediate couplers;

the couplers and adapters being connectable end-to-end to form an extension in which the relative pivoting of the longitudinal axes of the couplers allows flexible shape adjustment of the extension, while engagement of each projection with the respective slot between the couplers enables transfer of torque theretween under rotation of the drive end adapter by the tool.

Preferably the female end of each intermediate coupler has a hollow interior surrounded by a boundary wall in which the at least one slot is formed, and the male end of each intermediate coupler features the at least one projection.

Preferably the male end of each intermediate coupling comprises a rounded end surface facing away from the female end, and the hollow interior of the female end is peaked at a closed end thereof.

Preferably the male end of each intermediate coupling comprises a spherical portion from which the at least one projection extends outward.

Preferably the at least one projection comprises multiple projections and the at least one slot comprises multiple slots.

Preferably the multiple projections and the multiple slots are each at least three in number.

Preferably the multiple projections and the multiple slots are each at least four in number.

Preferably the multiple projections and the multiple slots are each at least five in number.

Preferably the first end of the drive end adapter comprises a rectangular opening for accommodating a rectangular drive of the tool.

Preferably the first end of the working end adapter comprises a rectangular drive stud.

There may be provided a bendable, shape-retaining tubular jacket closing around the intermediate couplers.

The tubular jacket may comprise flexible metallic tubing.

There may be provided annular closures adjacent opposite ends of the tubular jacket for retaining the intermediate couplings within the tubular jacket between said annular closures, the annular closures defining openings to accommodate access to the end adapters.

A length of the tubular jacket between may be sufficiently short to prevent separation between the male and female ends of the intermediate couplings.

According to a second aspect of the invention there is provided a tool extension comprising:

a plurality of intermediate couplers each having a body with a longitudinal axis and male and female ends pointing in opposing directions along said longitudinal axis, the female end of each intermediate coupler having a hollow interior surrounded by a boundary wall and one or more slots formed in the boundary wall and extending along the longitudinal axis, the male end of each intermediate coupler having one or more projections each extending in a direction having a radial component relative to the longitudinal axis, the male end of each intermediate coupler being insertable into the hollow interior of the female end of another of the intermediate couplers in an orientation sliding each projection of said male end into a respective slot of said female end in a fit that allows relative pivoting of the longitudinal axes of the intermediate couplers into and out of alignment with one another;

a drive end adapter having a first end configured for engagement by a drive element of a tool, and a second end configured for engagement with one of either the male end or the female end of one of the intermediate couplers; and

a working end adapter having a first end having a first end configured for providing an output action under use of the tool, and a second end configured for engagement with the other of either the male end or the female end of another of the intermediate couplers;

the couplers and adapters being connectable end-to-end to form an extension in which the relative pivoting of the longitudinal axes of the couplers allows flexible shape adjustment of the extension, while engagement of the projections and slots between the couplers enables transfer of torque theretween under rotation of the drive end adapter by the tool.

According to a third aspect of the invention there is provided a tool extension comprising:

a plurality of intermediate couplers each having a body with opposite ends spaced apart along a longitudinal axis, the intermediate couplers being coupled together end-to-end in a series in which relative pivoting of the longitudinal axes of the intermediate couplers into and out of alignment with one another is allowed;

a drive end adapter having a first end configured for engagement by a drive element of a tool, and a second end engaged with a first end-one of the intermediate couplers at a first end of the series;

a working end adapter having a first end having a first end configured for providing an output action under use of the tool, and a second end engaged with a second end-one of the intermediate couplers at a second end of the series; and

a bendable, shape-retaining tubular jacket closing around the intermediate couplers;

the relative pivoting of the longitudinal axes of the couplers providing flexibility by which a shape of the extension can be changed through manual adjustment, and the tubular jacket retaining said shape after each said adjustment.

According to a fourth aspect of the invention there is provided a flexible transmission device comprising:

a series of internal couplers including a first-end internal coupler at a first end of said series, a second-end internal coupler at a second end of said series, and at least one intermediate internal coupler connected between said first-end internal coupler and said second-end internal coupler, said first-end internal coupler, said second-end internal coupler, and said at least one intermediate internal coupler having respective bodies each with a respective longitudinal axis, the respective bodies of said at least one intermediate internal coupler and said first-end internal coupler each having a male end pointing in a first direction along the respective longitudinal axis, the respective bodies of said at least one intermediate internal coupler and said second-end internal coupler each having a female end pointing in an opposite second direction along the respective longitudinal axis, the male and female ends having opposing ones of at least one recessed slot having an axial length and a radial depth relative to the respective longitudinal axis and at least one projection having a radial extent relative to the respective longitudinal axis, the axial length of each slot exceeding a width of said slot, which exceeds a diameter of the projection, and each male end having been inserted into a hollow interior of a respective one of the female ends in an orientation sliding each projection into a respective slot in a fit that allows relative pivoting of the longitudinal axes of the series of internal couplers into and out of alignment with one another, whereby the series of internal couplers form a transmission shaft in which the relative pivoting of the longitudinal axes of the series of internal couplers allows flexible shape adjustment of the transmission shaft, while engagement of each projection with the respective slot enables transfer of torque from one of the first and second ends of the series of internal couplers to the other of the first and second ends of the series of internal couplers by rotation of either of the first-end internal coupler or the second-end internal coupler; and

an outer casing comprising a series of links including a first end link, a second end link and at least one intermediate link connected between the first end link and the second end link, the first end link, the second end link and the at least one intermediate link each comprising a respective collar having a respective cylindrical axial through-bore in which the respective body of a respective one of the series of internal couplers is at least partially received, the respective collars of the at least one intermediate link and the second end link closing respectively around the respective bodies of the at least one intermediate internal coupler and the second-end internal coupler at portions of said bodies of said at least one intermediate internal coupler and said second-end internal coupler that surround the hollow interiors of the female ends of said bodies of said at least one intermediate internal coupler and said second-end internal coupler, each neighbouring pair of links in the series of links being connected by a respective pivotal connection enabling relative pivoting of the neighbouring pair of links about a pivot axis that crosses through the respective collar of one of said neighbouring pair of links, and through the hollow interior of the female end of the respective body of the respective one of the series of internal couplers that is at least partially received in said respective collar of said one of said neighbouring pair of links, on a diameter line of said respective bore of the respective collar of said one of said neighbouring pair of links;

wherein the respective bodies of the series of internal couplers are respectively rotatable, relative to the series of links of the outer casing, about the respective longitudinal axes of the respective bores of the respective collars of the series of links of the outer casing to enable rotation of the transmission shaft inside the outer casing, while relative movement between said each pair of neighboring links of the outer casing is limited to the movement about the pivot axis of the pivotal connection therebetween; and

wherein the series of internal couplers are free floating within the respective axial through-bores of the respective collars of the links of the outer casing with axial play present among the series of internal couplers, the axial playing being limited to an amount sufficiently small to prevent separation between the male and female ends of the series of internal couplers.

Preferably the pivot axes of the pivotal connections between the links of the outer casing are all parallel with one another.

Preferably the end links comprise stop features arranged to block sliding of the internal couplers out from the ends of said series of links.

The stop feature of each end link may comprise an annular end flange projecting inward from a remainder of the collar of said end link.

An axial length of the collar of each intermediate link may vary around a circumference of said collar, the axial length being greater at a first plane containing the pivot axis of the pivotal connection of said intermediate link to a next link in the series than at a second plane lying perpendicular to said first plane.

A gap may exist between each intermediate link and the next link at the first plane containing the pivot axis of the pivotal connection of said intermediate link to the next link.

The collar of each intermediate link may comprise a flat annular end face at an end of said collar through which the hollow interior of the respective internal coupler receives the male end of another one of the internal couplers.

The collar of each intermediate link may comprise a second annular end face opposite the flat annular end face, the second annular end face having a smooth transition from a maximum axial length of the collar at the first plane to a minimum axial length of the collar at the second plane.

The second annular end face may be a peaked annular end face defining a peak at a diametral plane of the collar where an axial length of the collar is greatest, and smoothly contouring to the minimum axial length at a second diametral plane perpendicular to that at which the peak is located.

In one embodiment, the axial-through bore of each collar cylindrical, and the internal couplers are free floating within the cylindrical axial through-bores of the outer casing with axial play present among the internal couplers, the axial playing being limited to an amount sufficiently small to prevent separation between the male and female ends of the intermediate couplers

In one embodiment the flexible transmission device consists only of the casing and the internal couplers.

In one embodiment the casing contains only said internal couplers.

In one embodiment the axial through bores of the intermediate links contain only the internal couplers, and are free of any components other than the internal couplers.

In one embodiment the flexible transmission device consists only of the internal couplers and the links of the outer casing.

Alternatively, the casing may further comprise one or more retaining rings to retain the series internal couplers within the casing, and wherein the one or more retaining rings are installed only at one or both of the end links.

Preferably said one or more retaining rings consists of only one retaining ring installed at a respective one of the two opposing end links.

The casing may comprise at least one stiffening element running through the outer links at a location outside of the axial through bores of said series of outer links.

The pivotal connection between each pair of neighbouring links of the outer casing may comprise a pair of diametrically opposite lugs externally secured to the collar of one of said pair of neighbouring links and a pinned connection of each lug to the collar of the other of said pair of neighbouring links.

An external periphery of the collar of each link of the outer casing may comprise flattened areas underlying the lugs of the pivotal connection of said link to an adjacent link, the pinned connection of each lug being made at a respective one of said flattened areas.

Preferably one of the first and second end couplers comprises a drive end adapter having an outer end thereof opposite the intermediate couplers configured for engagement by a drive element of a tool; and the other of the first and second end couplers comprises a working end adapter having an outer end thereof configured for providing an output action under use of the tool, whereby the flexible transmission device is operable as a flexible tool extension through rotation of the transmission shaft by the tool.

Preferably the portions of the bodies of the internal couplers that surround the hollow interiors of said bodies share a same-size externally cylindrical shape which follows an internally cylindrical shape shared by the axial bores of the collars of the links.

According to a fifth aspect of the invention there is provided a flexible transmission device comprising:

a series of internal couplers connected together end to end by ball and socket joints each formed by mating ball and socket ends of an adjacent pair of internal couplers in said series, the ball and socket joints being constrained against relative rotation between each adjacent pair of internal couplers in said series about a longitudinal axis of each internal coupler in said pair such that the ball and socket joint will allow relative tilting between said longitudinal axes while effecting driven rotation of said internal coupler of said pair about the longitudinal axis thereof under rotation of the other internal coupler of said pair about the longitudinal axis thereof; and

an outer casing comprising a series of outer links each comprising a collar disposed about a respective one of the internal couplers to support said internal coupler at least partially inside a cylindrical axial through-bore of the collar in a manner concentrically rotatable therein, with each adjacent pair of the links being connected together by a pivotal connection enabling relative pivoting between said pair of links about a pivot axis that lies on a diameter line of a respective one of the through-bores of said adjacent pair of links and passes through a respective one of the ball and socket joints between the internal couplers;

wherein each internal coupler is rotatable relative to the link in which the internal coupler is at least partially received about a longitudinal axis of the bore of said link to enable rotation of the series of internal couplers as a flexible shaft inside the outer casing; and

wherein the internal couplers are free floating within the cylindrical axial through-bores of the outer casing with axial play present among the internal couplers, the axial playing being limited to an amount sufficiently small to prevent separation between the male and female ends of the intermediate couplers.

Preferably the couplers each comprise one of the ball ends and one of the socket ends, the ball ends of the internal couplers all pointing in a first direction along the series and the socket ends pointing in an opposing second direction along the series.

According to a sixth aspect of the invention, there is provided a flexible transmission device comprising:

a series of internal couplers connected together end to end by joints that are arranged to each allow relative tilting between longitudinal axes of a respective adjacent pair of said internal couplers while also enabling driven rotation of one internal coupler of said pair about the longitudinal axis thereof under rotation of the other internal coupler of said pair about the longitudinal axis thereof; and

an outer casing comprising a series of outer links having the internal couplers rotatably received within axial through bores of the outer links in a manner enabling rotation of the series of internal couplers as a flexible shaft inside the outer casing, the outer links being connected together in adjacent pairs by pivotal connections enabling relative pivoting between said links about pivot axes perpendicular to the longitudinal axes of the internal couplers; and

at least one elongated bendable shape-retaining stiffening element running through the outer links at a location outside of the axial through bores of said outer links to impart a shape-retaining tendency to the casing that resists relative pivoting between the outer links.

Preferably the casing comprises an outer passage defined separately of the axial through bores by end-to-end communication of channels defined respectively in the series of the outer links, the stiffening element extending from channel to channel to span the series of the outer links in the resulting outer passage.

Preferably the outer passage passes through the pivot axes of the pivotal connections provided between the outer links.

Preferably the outer passage passes through mating male and female elements of the pivotal connections between the outer links.

At each pivotal connection, preferably a smaller end of one of the channels communicates with a larger end of a next one of the channels, the smaller end being narrower than the larger end in a plane normal to the pivot axes of the pivotal connections.

Preferably the channels are each tapered to gradually widen from end to end in the plane normal to the pivot axes of the pivotal connections.

According to a seventh aspect of the invention, there is provided a flexible tool extension comprising:

a flexible transmission shaft comprising:
a series of couplers connected together end to end by joints that are each arranged to allow relative tilting between longitudinal axes of a respective adjacent pair of said internal couplers while also enabling driven rotation of one internal coupler of said pair about the longitudinal axis thereof under rotation of the other internal coupler of said pair about the longitudinal axis thereof;
a drive end adapter having a first end configured for engagement by a drive element of a tool, and a second end coupled to a first end coupler of the series of couplers at a first end of said series of couplers; and
a working end adapter having a first end with a drive stud shaped for receipt thereof in a mating drive opening of a wrench socket, and a second end coupled to a second end coupler of the series of couplers at a second end of said series of couplers; and

at least one magnet carried on the flexible transmission shaft adjacent a proximal end of the drive stud nearest the first end coupler at a location radially outward from an axis of the drive stud to provide a magnetic attraction force acting in a direction drawing the wrench socket toward the proximal end of the drive stud.

Preferably there is provided an outer casing in which the flexible transmission shaft is rotatably disposed, wherein the at least one magnet is mounted to the outer casing at an area around an opening of the casing through which the working end adapter projects to expose a distal end of the drive stud outside of said casing for receipt of the wrench socket on said drive stud from the distal end thereof.

### BRIEF DESCRIPTION OF THE DRAWINGS

In the accompanying drawings, which illustrate exemplary embodiments of the present invention:

FIG. 1 is a schematic side view of a flexible tool extension according to a first embodiment of the present invention with a flexible jacket thereof bent into a non-linear shape curving through ninety degrees and partially cut away to illustrate internal components of the extension.

FIG. 2 is a partially exploded view of internal components of a flexible tool extension similar to that of FIG. 1.

FIG. 3A is a first perspective view showing a male end of an intermediate one of the internal components of the flexible tool extensions of FIGS. 1 and 2.

FIG. 3B is a second perspective view showing an opposing female end of the intermediate component of FIG. 3A.

FIG. 4A is a female end view of an intermediate component like that of FIG. 3.

FIG. 4B is a male end view of the intermediate component of FIG. 4A.

FIG. 4C is a side view of the intermediate component of FIGS. 4A and 4B.

FIG. 5A is a female end view of a drive end adapter cooperable with intermediate components of the type shown in FIG. 4 to operably connect the same to a drive tool.

FIG. 5B is a male end view of the drive end adapter of FIG. 5A.

FIG. 5C is a side view of the drive end adapter of FIGS. 5A and 5B.

FIG. 6A is a female end view of a working end adapter cooperable with intermediate components of the type shown in FIG. 4 to operably connect the same to a socket.

FIG. 6B is a male end view of the working end adapter of FIG. 6A.

FIG. 6C is a side view of the working end adapter of FIGS. 6A and 6B.

FIG. 7 is a perspective view of a flexible tool extension according to a second embodiment of the present invention, where an outer casing or housing is formed by a series of collar-shaped links pivotally connected to one another on parallel axes.

FIGS. 8A and 8B are top and side views of the outer casing of the flexible tool extension of FIG. 7.

FIG. 9 is a perspective view of a single intermediate link of the outer casing of the flexible tool extension of FIG. 7.

FIG. 10 is a partially exploded perspective view of some of the internal components and one of the intermediate casing links of the flexible tool extension of FIG. 7 to illustrate the structure of the internal components and how they fit within the casing.

FIG. 11 is a partial cross-sectional view of the flexible tool extension of FIG. 7 as taken along a central longitudinal plane thereof.

FIG. 12A is a top view of a flexible tool extension according to a third embodiment of the present invention featuring a modified version of the second embodiment casing which incorporates a pair of stiffening elements to impart a shape-retaining tendency to the extension.

FIG. 12B is a partially sectioned view of the casing of the flexible tool extension of FIG. 12A with select links of the casing cut away along line B-B thereof.

FIG. 12C is a cross-sectional view of the flexible tool extension of FIG. 12A as viewed along line C-C of FIG. 12B.

FIG. 13A is a side view of the flexible tool extension of FIG. 12A with an internal shaft of the tool extension removed from an outer casing thereof.

FIG. 13B is a side view of the tool extension of FIG. 13A with the internal shaft and outer casing disassembled.

FIGS. 14A, 14B, 14C and 14D are perspective, end, top and side views, respectively, of an intermediate link of the outer casing of the flexible tool extension of FIG. 12A.

FIGS. 15A, 15B, 15C and 15D are perspective, side, male-end and female-end views, respectively, of an intermediate internal coupler of the flexible tool extension of FIG. 12A.

FIGS. 16A, 16B, 16C and 16D are perspective, top, inner-end and outer-end views, respectively, of a modified drive-end link body of the outer casing of the flexible tool extension of FIG. 12A.

FIGS. 17A, 17B, 17C, 17D and 17E are perspective inner-end, perspective outer-end, top, axial inner-end and axial outer-end views, respectively, of a drive-end internal adapter of the flexible tool extension of FIG. 12A.

FIGS. 18A, 18B, 18C and 18D are perspective, end, side and top views, respectively, of an exploded working-end link of the outer casing of the flexible tool extension of FIG. 12A.

FIGS. 19A, 19B, 19C and 19D are perspective, male-end, female-end and top views, respectively, of an intermediate internal coupler of the flexible tool extension of FIG. 12A.

### DETAILED DESCRIPTION

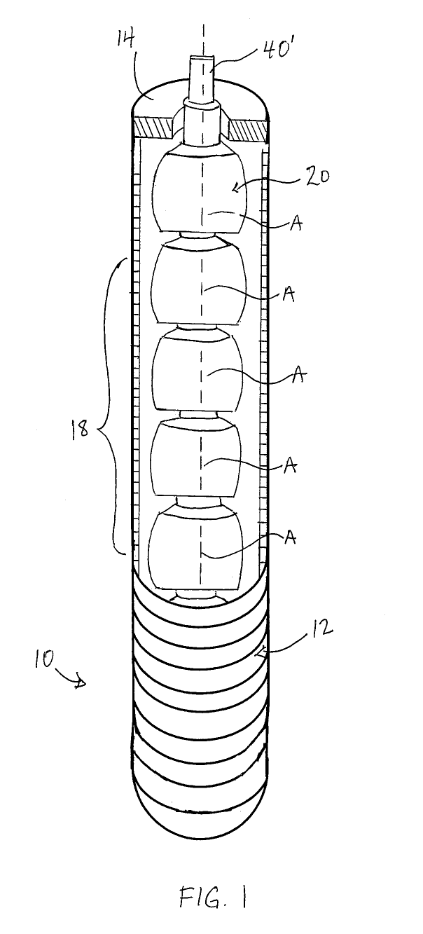

FIG. 1 shows a flexible tool extension 10 according to a first embodiment of the present invention which can be coupled between the female rectangular drive opening of a socket and the male rectangular drive stud of a socket wrench or impact gun in order to allow rotational drive of the socket by the wrench or impact gun without direct axial alignment therebetween.

The extension features a flexible outer jacket 12 provided in the form of a length of conventional flexible metallic conduit or tubing having an annular closure 14 (only one of which is visible in the drawings) at its two ends to define a housing in which a number of internal components are maintained. These internal components include a drive end adapter 16 (not visible in FIG. 1), a plurality of intermediate couplers 18, and a working end adapter 20, all connected together in series to run along the interior of the flexible jacket 12 with the two adapters 16, 20 respectively lying just inside the two closed ends of the jacket, and the plurality of intermediate couplers 18 connected in series between the two adapters.

The commercially available flexible metallic conduit or tubing 12 is of a helically wound formation providing a tubular configuration which can be manually bent into various curved formations to give the length of tubing different overall shapes, while self-retaining the established shape until later reshaped through manipulation by suitable force. The tubing is thus shape adjustable, but also retains its given shape between adjustments.

Each of the intermediate couplers 18 is of the same shape and configuration, having a single unitary body with a central longitudinal axis A and opposing male and female ends 22, 24 spaced apart along this axis A and pointing in opposite directions therealong. A hollow portion of the body defines the female end 22 thereof, featuring an outwardly convex wall 26 closing concentrically around the longitudinal axis A. The convex outer surface of the wall 26 defines the outer circumference of this portion of the body, while the opposing inside of the wall forms the boundary of its hollow interior. The hollow interior features a central cylindrical space or bore 28, combined with a plurality of slots 30 equally spaced apart around the longitudinal axis, each slot 30 having a depth cutting into the interior of the wall 26 in a direction moving radially outward cylindrical bore 28 and a length running parallel to the longitudinal axis from the open female end 22 of the body. The annular wall 26 is integrally capped off at one end thereof, as shown at 32, thereby defining a closed end 34 of the hollow female portion of the body.

The male portion of the body that defines the male end 24 thereof features a cylindrical base or neck 38 that is centered on the longitudinal axis A and projects from the capped end 32 of the female portion to the side thereof opposite the hollow interior of the female portion. The diameter of the neck 38 is less than the end of the female portion from which it projects. At the distal end of the neck 38, the male portion features a generally ball-shaped protuberance 40 with a spherically curved outer surface of greater radius than the cylindrical neck, thus presenting a domed convex surface centered on the longitudinal axis to point the peak of the dome away from the female end 22 of the body, thereby define the apex of the male end 24 of the body. The male portion of the body is completed by a plurality of cylindrical projections 42 jutting outward from the protuberance in radial directions relative to the longitudinal axis A, thus defining pin-shaped or peg-shaped features projecting radially outward from the remainder of the male portion of the body.

The number of projections 42, and the angular spacing apart thereof around the longitudinal axis, match those of the slots 30 in the female portion of the body. The diameter of each projection 42 is somewhat less than the width of each slot 30, and even more-so less than the length of each slot 30. The radial distance from the longitudinal axis A that is reached by each projection 42 is less than the radial distance from the longitudinal axis A to the inner surface of the annular wall 26 at each slot 30 in the female portion of the body, but greater than the radial distance from the longitudinal axis A to the inner surface of the annular wall 26 of the female portion at the areas between the slots 30. That is, the radial extent of each projection 42 exceeds the radius of the central cylindrical bore 28 of the female portion, but is less tan the radial extent of the slots 30 of the female portion.

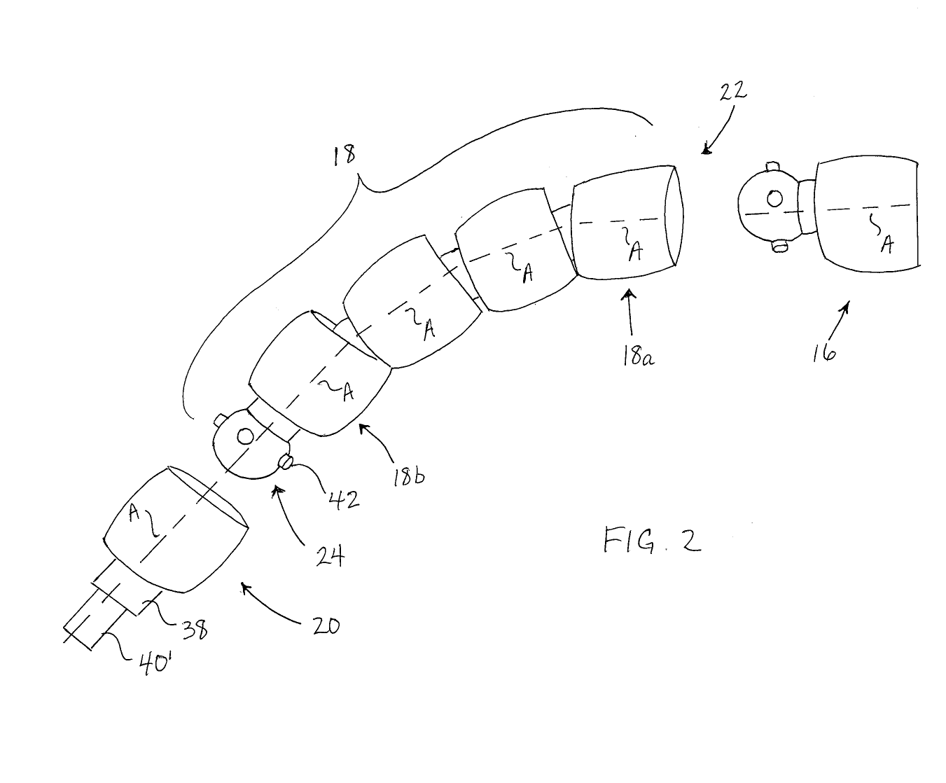

With this relative sizing of the projections and slots, and the matching relative positioning among the slots and projections, the male end 24 of any one of the intermediate couplings 18 is insertable into the female end 22 of any other one of the intermediate couplings 18 in a manner sliding the projections 42 of the first coupling respectively into the slots 30 of the other coupling. With the two couplings engaged together end-to-end in this manner, rotation of one of the couplings 18 about its longitudinal axis will cause rotation of the other coupling through contact between each projection 42 and a side of the slot 30 in which the projection is received. With the depth of the slots 30 exceeding that which would be required to achieve a snug fitting of the projections in the slots with the axes of the two couplings in fully-coincident alignment, tilting of the two axes relative to one another is allowed between the engaged-together couplings, whereby the two couplings can pivot relative to one another in directions bringing their axes into and out of alignment with one another. When a series of intermediate couplings 18 are engaged together end-to-end, as shown in FIG. 2, this relative pivoting between adjacent couplings allows the resulting assembly to flex between a linear configuration in which all the coupling axes A are aligned, and many different non-linear, curved or bent configurations in which at least some of the axes A are misaligned.

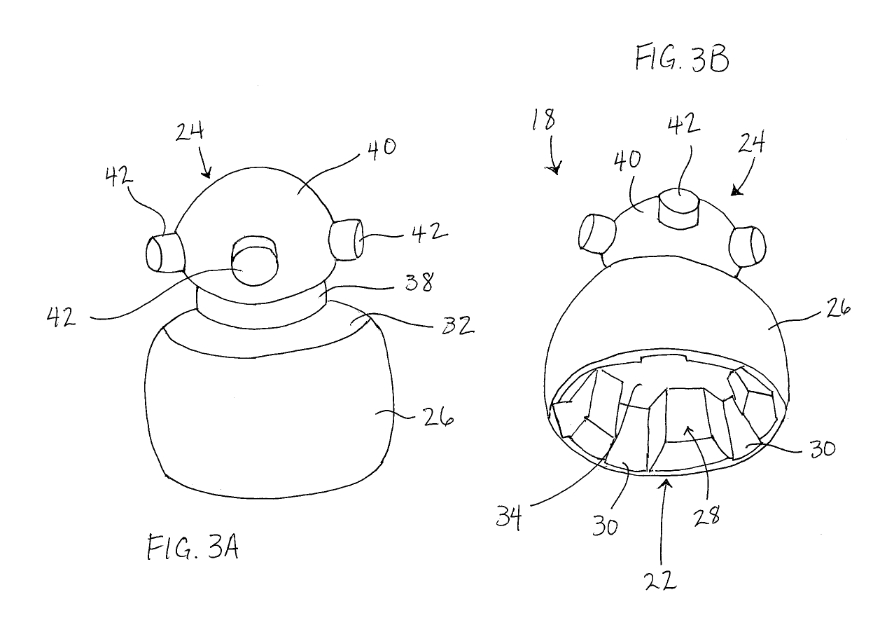

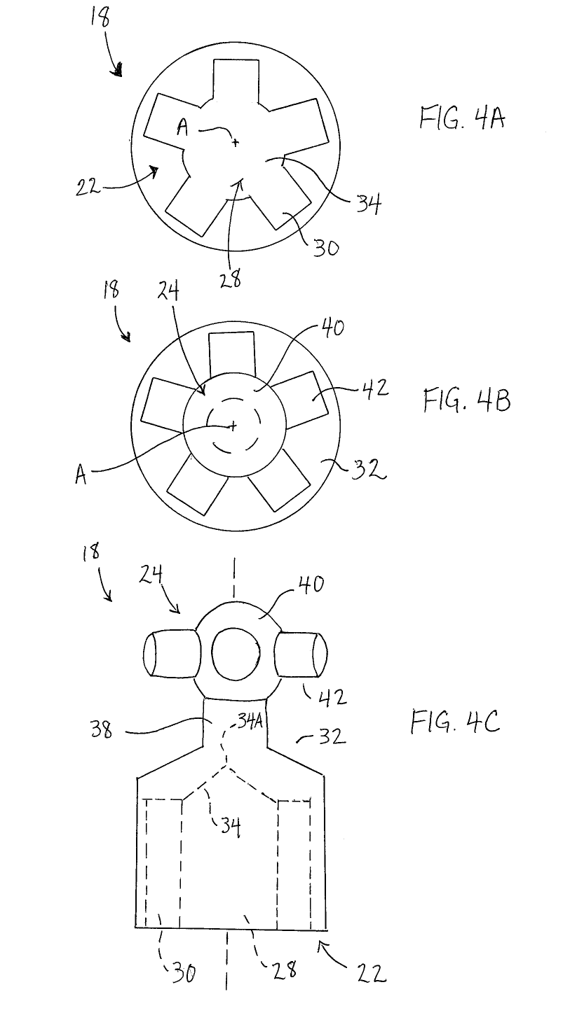

Referring to FIG. 4C, the closed end 34 of the hollow interior of the female portion of each coupling 18 has a domed or tapered configuration narrowing toward the male end of the body to form a peak 34a at the central axis A. The use of a domed or peaked interior at the female portion and a spherical or rounded end surface at the male portion provides for smooth movement between mated together couplers, as the rounded end of the male portion of one coupler can smoothly slide over and remain in constant contact with a frustoconically tapered end, or a conformingly frustospherical dome, of the female portion of the next coupler.

The end adapters 16, 20 are attached to opposite ends of the series of intermediate couplings 18. FIG. 2 illustrates connection of the drive end adapter 16 to the female end of a drive end intermediate coupling 18a (i.e. the intermediate coupling that is located nearest the tool when the assembled extension 10 is connected to the tool), and connection of the working end adapter 20 to the male end of a working end intermediate coupling 18b (i.e. the intermediate coupling that is located furthest from the tool, and nearest to the socket, when the assembled extension 10 is connected to between the tool and socket).

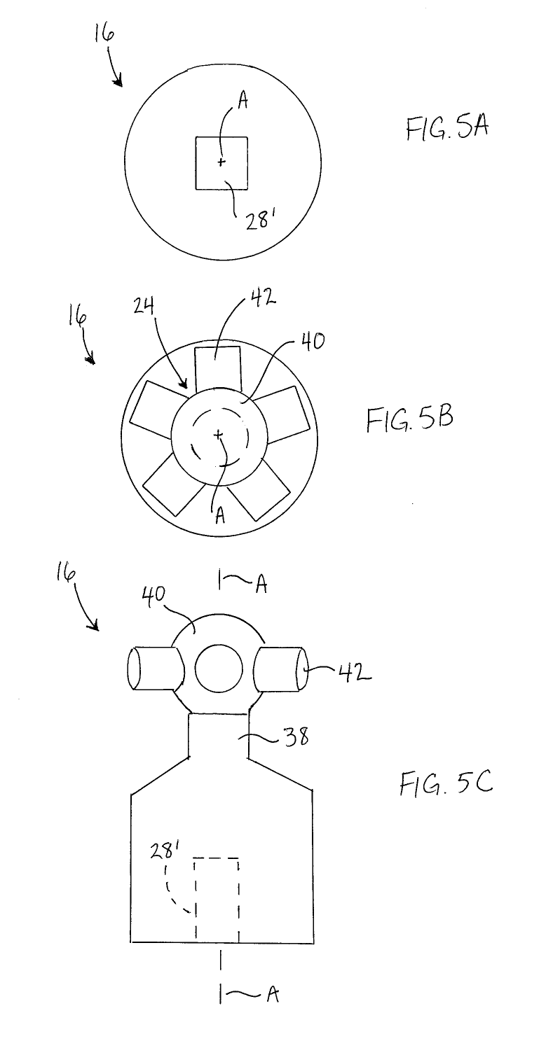

In the illustrated embodiments, the drive end adapter 16 features the same male body portion as each intermediate coupling 18, and differs from the intermediate couplings only in that the hollow interior of the female body portion is differently configured. More particularly, with reference to FIGS. 5A and 5C, the female portion of the drive end adapter 16 has a rectangular bore 28′ instead of the round cylindrical bore and radial slot combination of the intermediate couplers 18. This way, the male portion of the drive end adapter 16 can be engaged with the drive end intermediate coupling 18a in the same manner as the engagement between adjacent intermediate couplings, while the female portion of the drive end adapter 16 can receive the male rectangular drive (usually square) of a socket wrench or impact gun and accordingly transfer torque from the socket wrench or impact gun to the series of interconnected couplers 18.

In the illustrated embodiments, the working end adapter 20 features the same female body portion as each intermediate coupling 18, and differs from the intermediate couplings only in that the protuberance and accompanying projections at the end of the neck is replaced with a rectangular drive stub 40′ projecting axially from the neck. The drive stub 40′ is of the same cross-sectional size as the rectangular drive of the tool on which the extension is intended for use. Accordingly, a socket having a female rectangular drive opening suitable for use with that tool can instead be engaged by the working end adapter 20 of the flexible extension in order to complete the torque-transmitting connection between the tool and the socket.

It will be appreciated that the extension may employ end adapters configured for rectangular drives of different sizes, and may employ drive features of non-rectangular shape if intended for tools employing other drive shapes.

Referring back to FIG. 1, the flexible extension may be assembled as follows. The couplers and adapters are installed end-to-end in series, and one of the annular closure members, for example a washer, is fixed to an end of the flexible tubing to close off an outer portion of the opening at this end of the tubing. The assembled series of couplers and adapters 16, 18, 20 are placed inside the flexible tubing 12 with the female end of the drive end adapter 16 abutted up against the inside face of this first annular closure member, whereby the rectangular drive opening 28′ in this end of the drive end adapter is accessible through the central opening of the annular closure member to later receive the rectangular drive of the tool for use of the extension. The length of the flexible tubing is sufficient to contain the series of intermediate couplers 18, the drive end adapter 16 coupled at one end of the intermediate coupler series 18, and the female portion of the working end adapter 20 at the other end of the intermediate coupler series 18. The second annular closure member 14, for example another washer, is fixed to the remaining open end of the tubing in a position closing around the male portion of the working end adapter 20 that projects from this end of the tubing. With the male portion of the working end adapter 20 passing through the central opening in the annular closure member, the rectangular drive stub 40′ is thus positioned outside the flexible tubing 12 for engagement with the female rectangular drive opening of the socket. The length of the flexible tubing between the annular closures 14 at its ends is short enough to prevent separation of any of the male-female engagements between the internal components, thereby ensuring that rotation of the drive end adapter by the tool will always drive rotation of the working end adapter and the socket attached thereto.

With the extension coupled between the wrench or impact gun and the socket, the flexible housing can be bent into any desired shape suitable for a particular application, with the male-female coupling of the internal components allowing pivoting therebetween to accommodate this shape adjustment while maintaining a rotational coupling between all components from one end of the extension to the other. The jacket not only contains the internal components and maintains them in their functional assembled state while allowing flexing between them to change the shape of the extension, but also acts to maintain any selected shape during use of the extension.

The adapters in the first illustrated embodiment each have male and female ends. Another variation could have a drive end adapter with two female ends, and a working end adapter with two male ends, in which case the orientation of the intermediate couplers would be reversed from that shown (i.e. the male ends of the intermediate couplers would point toward the drive end, not the working end, of the extension).

FIGS. 7 to 10 illustrate a second embodiment of the present invention, which differs from the first embodiment in that the outer surface of the wall 26′ of each coupler and adapter is purely cylindrical instead of being convexly contoured along the longitudinal axis of the coupler body, and in that an outer casing 12′ formed from a series of pivotally connected, collar-shaped links replaces the first embodiment housing formed of flexible metal tubing. Additional detail on the second embodiment is provided as follows.

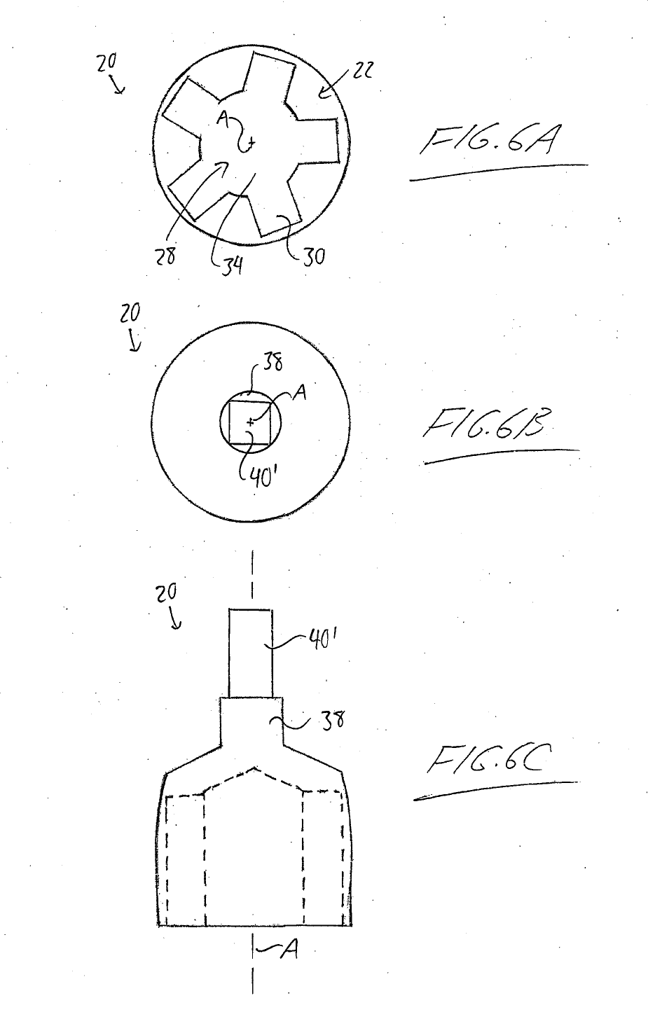

FIG. 9 illustrates a single intermediate link 50 of the casing 12′. The link 50 features a collar 52 with a cylindrical through-bore 54 passing axially therethrough. A rear or trailing end 54 of the collar 52 features a flat annular end face, while the opposing front or leading end of the collar has a peaked end-face configuration, where the annular end face 56 of the collar 52 has two planar halves 58 sloping obliquely and symmetrically toward the rear end of the collar from a diametral plane of the collar bore. The axial length of the collar is greatest at this diametral plane of the collar bore, running axially from the resulting peak 60 of the front annular end face 56 of the collar to the plane of the flat rear end face of the collar. From this peak, the axial length of the collar gradually and smoothly reduces to a minimum at diametrically opposing points of the collar at a second diametral plane thereof perpendicular to the first.

The external periphery of the collar 52 features two lugs or ears 62 fixed thereon at diametrically opposed positions on the collar at the first diametral plane where the front end face 56 of the collar has its peak and the collar has its maximum axial length. Each lug 62 projects axially from the collar 52 to an axial position outwardly past the maximum peaked extent 60 of the front face 56 of the collar 52. Near their distal ends, the lugs 62 feature respective pins or posts 64 that align with and extend inwardly toward one another on an axis that lies perpendicular to the longitudinal axis of the collar bore in the first diametral plane of the collar.

Adjacent the rear end 54 of the collar 52, the exterior of the collar 52 features a pair of parallel, rectangular flats 66 at diametrically opposed positions around the collar exterior. In the illustrated embodiment, with the exception of the flats 66 and the lugs 62, the remainder of the exterior of the link 50 is cylindrical in form. At the same diametral plane at which the lugs and pins/posts 64 reside, a pair of diametrically opposite through-holes 68 extend radially through the collar 52 from the exterior flats 66 into the interior axial through-bore of the collar 52.

Referring to FIG. 7, the casing of the tool extension is made up of a plurality of identical intermediate links 50 of the above-described type connected together with a drive-end link 50a at one end of the series and a working-end link 50b at the opposite end of the series. The drive-end link 50a of the series differs from the intermediate links 50 and working-end link 50b in that it doesn't require the flats 66 and radial through-holes 68 near the rear end of its collar, and the working-end link 50b differs from the intermediate links and the drive-end link 50a in that it lacks the lugs 62 and the posts/pins 64 thereof at the front end of its collar. The two end links 50a, 50b also differ from the intermediate links in that they each feature an annular stop flange 70 jutting inwardly from the end of the collar lying opposite the intermediate links 50. That is, the working-end link 50b features the annular stop flange 70 at its front end and instead of the peaked front end face of the other links, as visible in FIG. 7, and the driving-end link 50a features the annular stop flange at its rear end.

The casing is assembled by engaging the pins/posts 64 at the front of each of the drive-end and intermediate links into the radial through-holes adjacent the rear of a neighbouring one of the intermediate and working-end links. Accordingly, each of the drive-end and intermediate links is pivotally connected to the next link of the series for relative pivoting between these adjacent links about the pivot axis defined by the pins/posts 64, which due to engagement of the pins/posts in the radial holes at the rear of next link, places this pivot axis on a diameter line of the axial through-bore of the link whose radial-holes are engaged by the pins/posts of the preceding link in the series. With the series of links coupled together for relative pivoting of the links about parallel pivot axes, the casing can flex and bend within a single plane to change the shape of the casing while maintaining the longitudinal axes of the casing links in within that common single plane.

The axial distance from the front end peak 60 of each collar 52 of the drive-end and intermediate links to the pins/posts 64 on the lugs 62 of that collar and the axial distance from the flat rear end face of each intermediate and working-end link to of radial through-holes 68 thereof are such that a small gap G (FIG. 11) exists between each front end peak 60 and the flat rear face of the subsequent link of the series. If both ends of each link collar were flat, then the full pivotal range attainable between each pair of adjacent links would be determined by the size of this gap. However, the illustrated configuration where the front ends of the drive-end and intermediate links are concavely contoured to cut rearwardly away from a pair of diametrically opposite leading points spaced around the circumference of the collar increases the attainable degree of pivoting between two neighbouring links. Other embodiments may feature similar concavity at the rear ends of the intermediate and drive-end links to further increase the available degree of pivotal motion between adjacent links. However, the illustrated configuration with one flat end provides a greater average axial length of the collar around its circumference to provide greater stability in maintaining concentric positioning of the respective coupler within the collar of the link.

The inner face or underside 62a of each lug, i.e. the side thereof from which the posts/pins project, is flat, and overlies a respective one of the flats 66 on the next link in the series throughout the full pivotal range of motion between the adjacent links. Providing this flattened area 66 at the rear of the leading link of the pair of links provides better resistance to twisting of the series of links, i.e. rotation of the trailing link about its longitudinal axis relative to the leading link, compared to if the pin-receiving holes of the leading link were located at a contoured exterior surface of the collar. The length of each pin/post is preferably such that any protrusion thereof into the internal axial bore of the collar of the next link is minimal or non-existent. In other words, the length of each pin-post is long enough to remain securely engaged the respective hole of the next link, but only exceeds the wall thickness of the collar of the next link at the respective flattened area of the collar exterior by a minimum amount, or not at all. In other embodiments, the pins/posts may engage into blind holes at the exterior of the collar instead of the through-holes, and in yet other embodiments, the pins/posts may be positioned externally at the rear of the collar and the corresponding holes positioned in the lugs, thereby accomplishing the same pivotal connection at the same location.

With reference to FIGS. 10 and 11, a plurality of identical intermediate couplers 18′ like those of the first embodiment (but with purely cylindrical exterior surfaces 26′ at the hollow portion of the body) are connected in series in the same manner as the first embodiment and inserted into the assembled series of casing links, along with a drive-end adapter 16′ and a working-end adapter 20′ at opposite ends of the series of couplers. Like the intermediate couplers, the end adapters are the same as those of the first embodiment, except that the exterior of the hollow portion of the body that defines the female end thereof is again externally cylindrical (i.e. uniform diameter over the axial length thereof rather than convexly contoured along the axial dimension).

Each coupler and adapter of the series inserted into the casing is partially received within the axial through-bore of a respective one of the casing links so that a substantial majority the hollow female portion of the coupler/adapter body lies inside the collar of that casing link. The male portions of the drive-end adapter and the couplers each project from the front end of the respecitve casing link into the rear end of the next casing link so as to situate the ball-shaped protuberance 40 of the male portion substantially inside that next casing link so as to engage with the hollow interior of the female portion of the next internal component inside the casing. The pivot axis P of each pivotal connection between adjacent casing links therefore not only passes diametrically through the axial through-bore of the leading one of these two links, but in doing so also passes diametrically through the hollow interior of the coupler or adapter whose female portion is housed within the collar of this leading one of the two adjacent links. In other words, considering the male/female engagement of each coupler-coupler or coupler-adapter pair inside the casing to be a constrained ball and socket joint (where the ball-shaped protuberance of the male end of one component cooperates with the hollow interior or ‘socket’ of the female end of the other component to allow tilting of the longitudinal axes of these components relative to one another in different directions, while the engagement of the projections of the male end in the slots of the female end constrains the components against relative rotation about their longitudinal axes), each ball and socket joint coincides with the location of the pivot axis of the pivotal connection between an adjacent pair of casing links, since the pivot axis crosses through the ball and socket of the joint.

The cylindrical shape of the female portion of each coupler/adapter is slightly less than the conforming cylindrical shape of the axial through-bore of the respective casing link, and so each coupler/adapter is concentrically rotatable within the collar of the respective casing link. The external casing can be curved or bent in a single plane to form a suitable shape for contouring the tool extension around a particular obstacle or obstruction preventing straight-on tool-access to a fastener through manipulation of the casing links about their pivotal connections with one another, and the joints between the internal adapters and couplers will allow the series of internal components to adapt to this desired shape accordingly. The rectangular drive stud of the tool is engaged into the rectangular bore of the female end of the drive-end adapter through a hole that is left open at the rear end of the drive-end link of the casing within the area bound by the stop flange of the link, and the tool is then used to rotate the drive-end adapter, thereby driving rotation of the full series of internal components right through to the working-end adapter, where a socket engaged on the rectangular drive stub 40′ of the working-end adapter can accordingly effect rotation of the fastener.

Through the use of the single-axis pivot connection between adjacent links of the casing, and the parallel orientation of these pivot connections between the casing links, the casing provides a great deal of stability to the flexible tool extension, preventing the assembly from flailing out of the desired shape configuration under driven rotation of the internal components by the tool. With the series of internal components captured in the casing by the stop flanges that prevent the internal end adapters from sliding out of the casing at the opposing ends thereof, and with the pivot axis between each pair of casing links lining up with a respective one of the constrained ball and socket joints of the internal components, prototypes of the invention have been found to provide a self-centering or self-stabilizing action where the ball and socket of each joint between the internal components will automatically find their natural, smoothly rotating, ideal axial positions in the collar of respective casing link within the small amount of axial play present among the couplers and adapters of the series of internal components. Accordingly, no extra retention pieces are needed to maintain engagement of the ball of each joint inside the respective socket. That is, the cylindrical bores of the casing links are free of any snap rings or any other features other than the internal couplers and adapters. The internal couplers and adapters are thus free-floating within the casing, each having a degree of axial play relative to the both the respective casing link and the next coupler or adapter in the series, but with the axial play being limited to an amount sufficiently small to prevent separation between the male and female ends of any of the internal couplers and adapters.

While all the pivot axes of the casing are parallel to one another in the preferred embodiment, where this configuration of the pivot axes provides the greatest flexibility in a plane normal to the singular pivot-axis direction, other embodiments including non-parallel pivot axes among the casing links are still within the scope of the present invention. The pivot axis of the casing at each joint of the internal couplers lends stability to the overall structure by substantially limiting the relative movement between the couplers of that joint to pivotal movement about that pivot axis. In one example of an alternate embodiment, the pivot axes of the casing alternate from one to the next along the series of links, wherein the position of each pivot axis relative to the cylindrical bore on whose diameter the axis lies is perpendicular to that of the next pivot axis (i.e. each pivot axis is perpendicular to the next when the casing is in a linear state with the longitudinal axes of the links aligned, whereby the pivot axes alternate between two perpendicular planes moving from one link to the next through the series while in this linear state).

It will also be appreciated that while the couplers of the second illustrated embodiment each feature opposing male and female ends, whereby the male ends all point in a common first direction along the series and the female ends all point in an opposing second direction, other coupler configurations are possible that will likewise achieve male/female ball-and-socket joints between each adjacent pair of couplers at locations where the pivot axes of the casing pass through those joints. Also, although use of the illustrated couplers with mating projections and slots in the ball and socket joints is preferred, other constrained ball and joint connections can be employed with the casing, for example using the hexagonally-faceted ball heads and hexagonal receptacles of aforementioned publication US 2011/0303053.

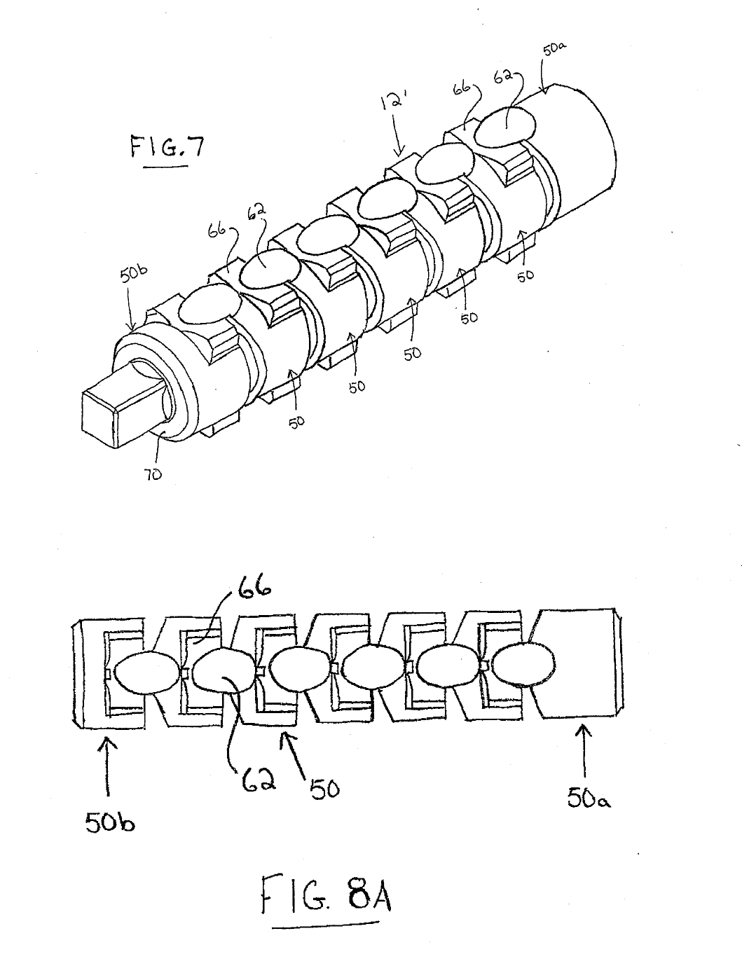

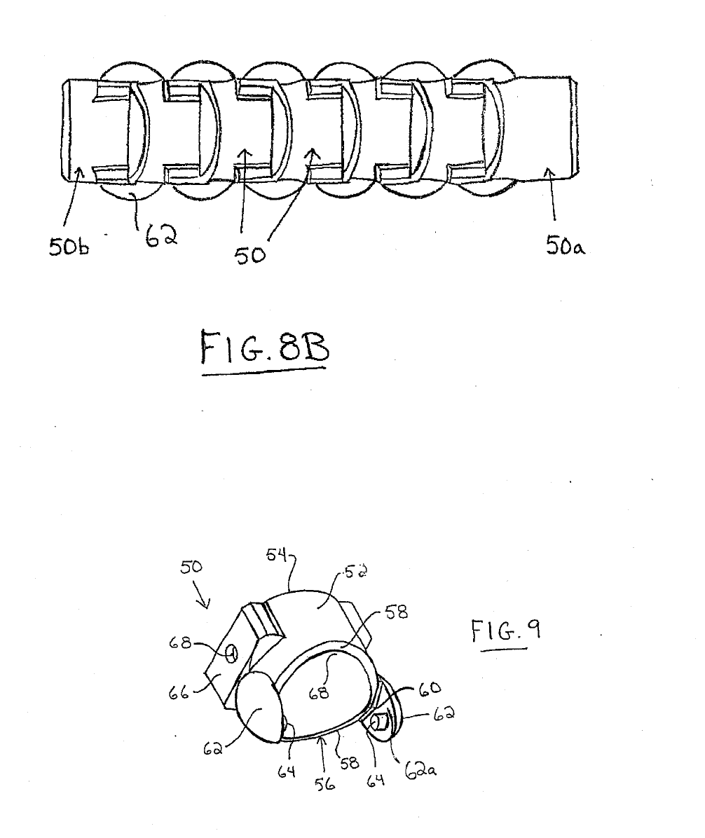

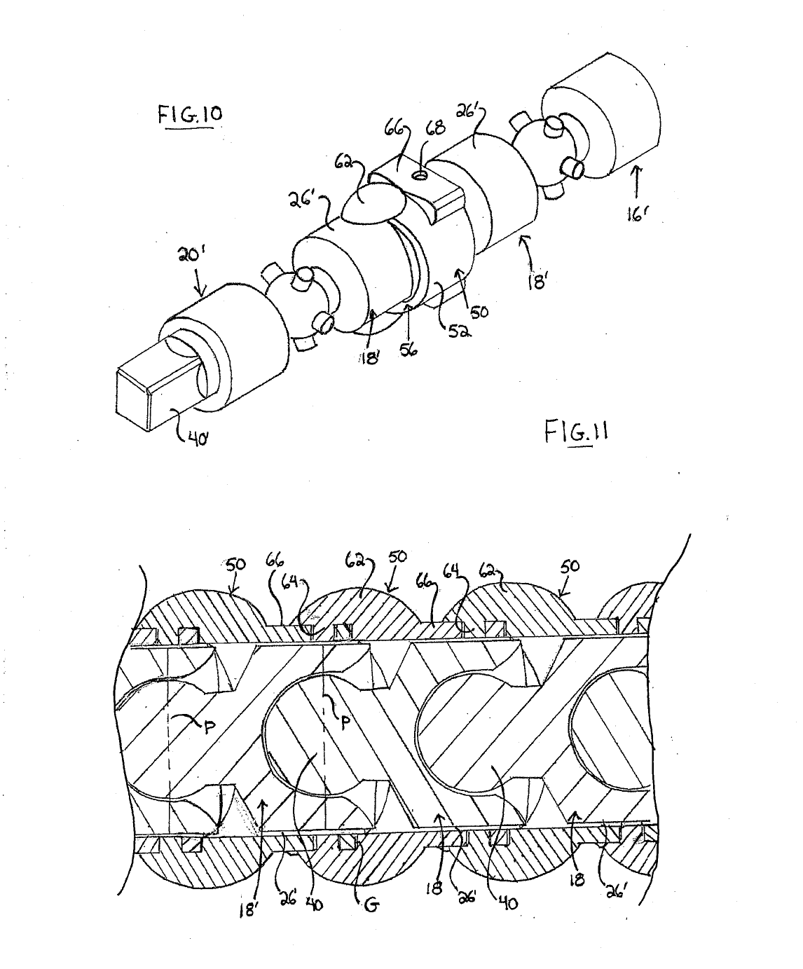

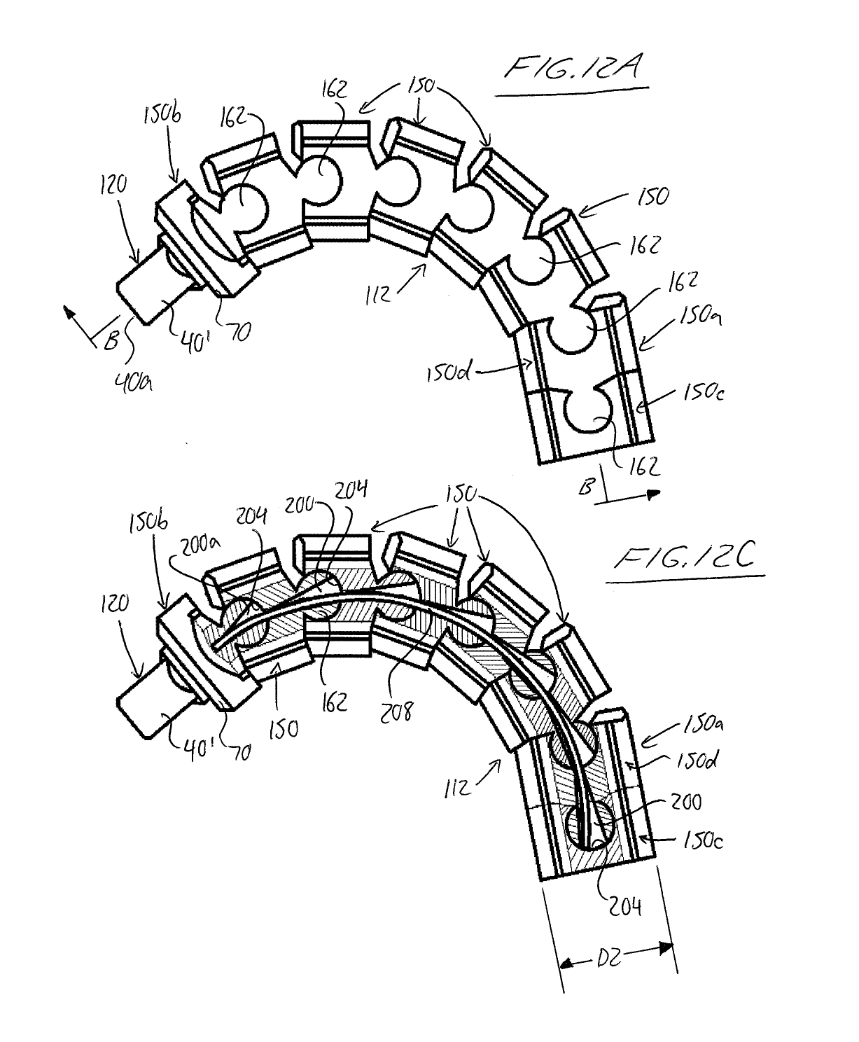

FIG. 12 illustrates a third embodiment that features some modifications to the casing of the second embodiment. Firstly, instead of a pivotal connection using a pair of lugs that reach from one link over the exterior of the next link for laterally pinned connection thereto, each intermediate link 150 in the third embodiment avoids the use of a pin and instead has a pair of rounded male ears 162 that engage into rounded female recesses 168 that jut into the corresponding end face of the collar of the next link. Each rounded ear 162 and each corresponding recess 168 has an arcuate span of greater than 180-degrees, whereby the open end of the recess at the end face of the collar of the link has a width less than the diameter of the mating male ear of the adjacent link so as to prevent withdrawal of the male ear from the respective recess. This maintains the connection between the two adjacent links, while the rounded shape of these mating male and female features 162, 168 allows pivoting between the two links about a diametrical axis passing through the internal bore of the recess-featuring link at the center of the recess 168 therein, thus providing the same pivot axis location as the second embodiment, whereby the pivot axis passes through the female socket of the internal component received in this link that defines the female recess feature of the pivotal connection in question.

This style of pivotal connection between adjacent casing members means that the mating male-female members of the connected pair of casing members are in-plane with one another, as best shown in FIG. 12B, unlike the second embodiment where the pin-carrying lug and corresponding hole-equipped flat of the connected casing members are in adjacent, but separate, parallel planes, and are interconnected laterally (i.e. radially, relative to the bore axes of the casing links) by the pin.

This in-plane mating of male and female elements 162, 168 on diametrically opposing sides of the casing links to form the pivotal connection between casing members in the third embodiment is used to define a pair of stiffener-receiving passages that run along these opposing sides of the casing 112 from one end link thereof to the other. As shown in the cross-sectional views of FIGS. 12B and 12C, a closed channel 200 extends axially through each ear and slot equipped side of each intermediate link 150 so as to reach from the inner end of the recess 168 furthest from the end of the collar into which the recess extends, onward to the distal end of the ear 162 of the same link furthest from the end of the collar from which the ear projects. In a plane perpendicular to the pivot axis of the pivotal connection formed by the mating of the ear 162 in the respective recess of the next link, the channel 200 is tapered so as to grow wider from the end 202 of the channel that opens into the recess 168 to the opposing end 204 of the channel 200 that opens from the ear 162 of the same link, as shown in FIG. 12B.

The drive-end link 150a of the casing 112 in FIG. 12 is formed by the assembly of a modified link body 150c with an unmodified link body 150d of the same structure as the intermediate links 150. The unmodified link body 150d is joined to the adjacent intermediate link in the same pivotal manner as described above for joining of each adjacent pair of intermediate links. The modified link body 150c has round recesses 168 of the same as the intermediate links, in which the ears 162 of the unmodified link body are received, but lacks its own respective pair of ears at the opposing end. The modified link body 150c also differs from the intermediate links in that its inward facing end is shaped to conform to the outward facing end of the unmodified link body, thus maintaining the two link bodies 150c, 150d in axially-aligned fixed positions relative to one another as no pivoting is allowed between them due to the flush abutment of the adjacent ends of these two link bodies.

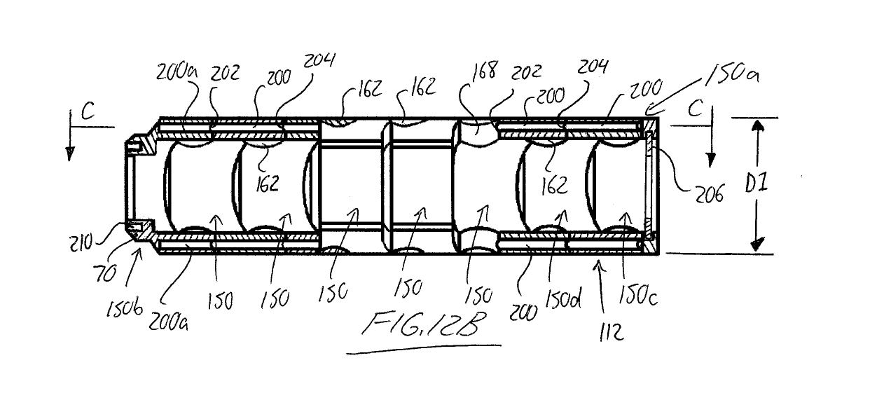

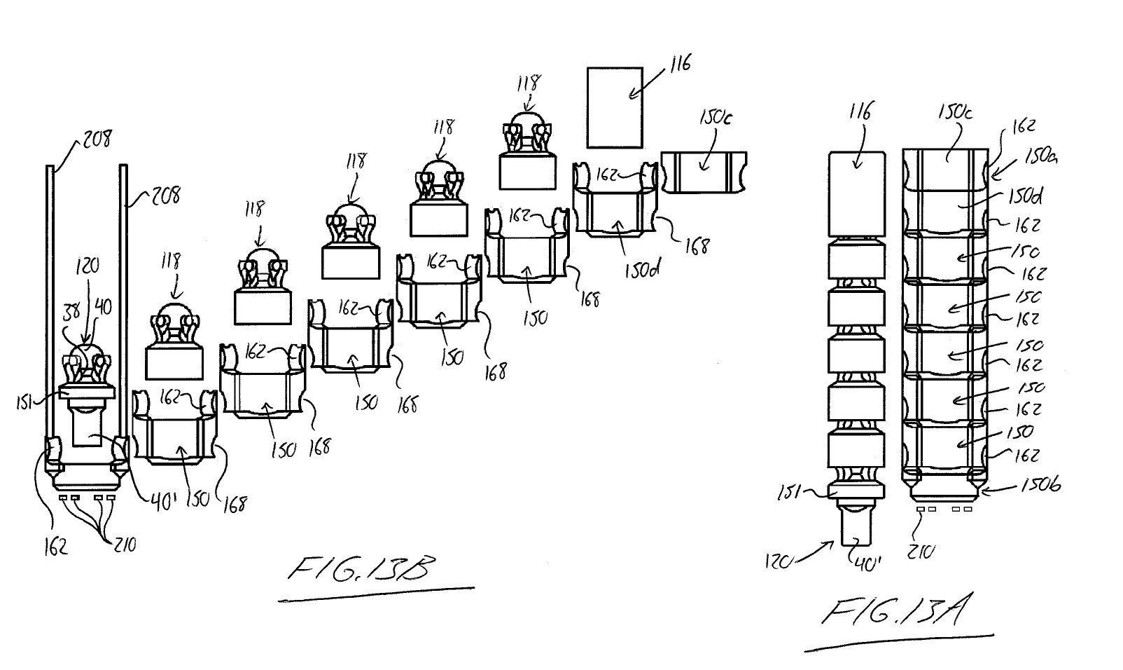

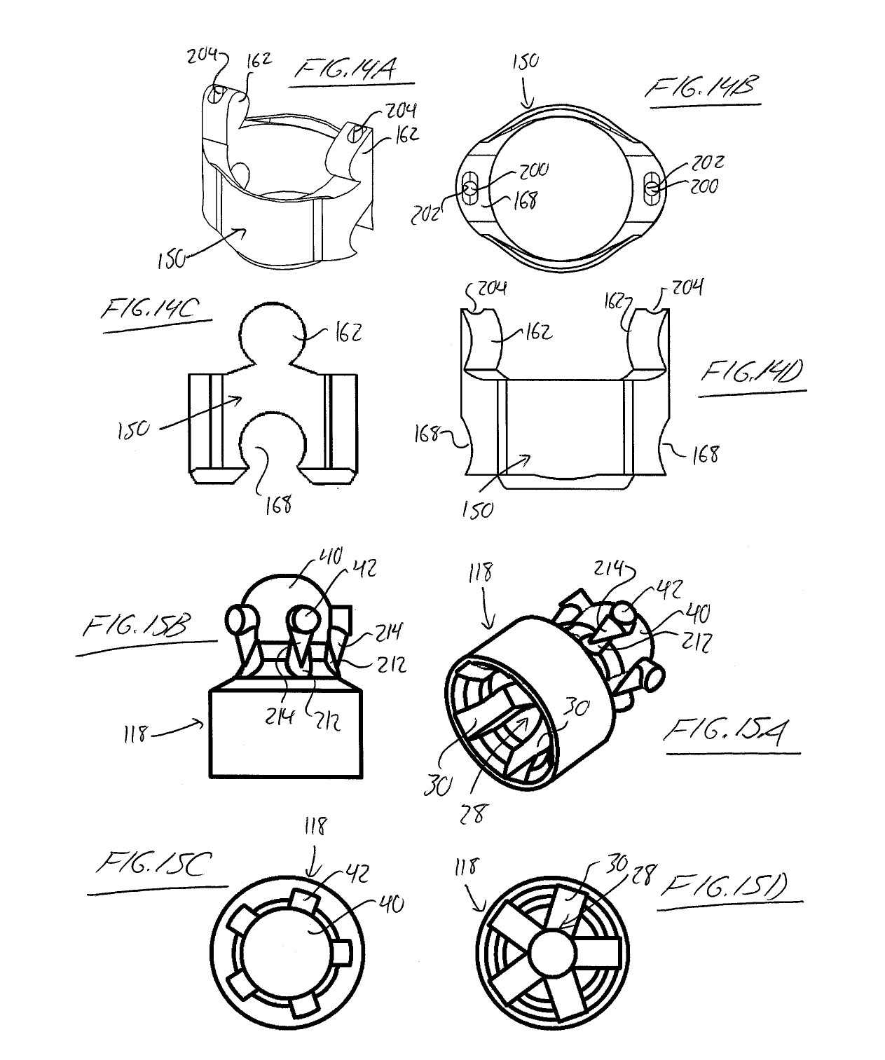

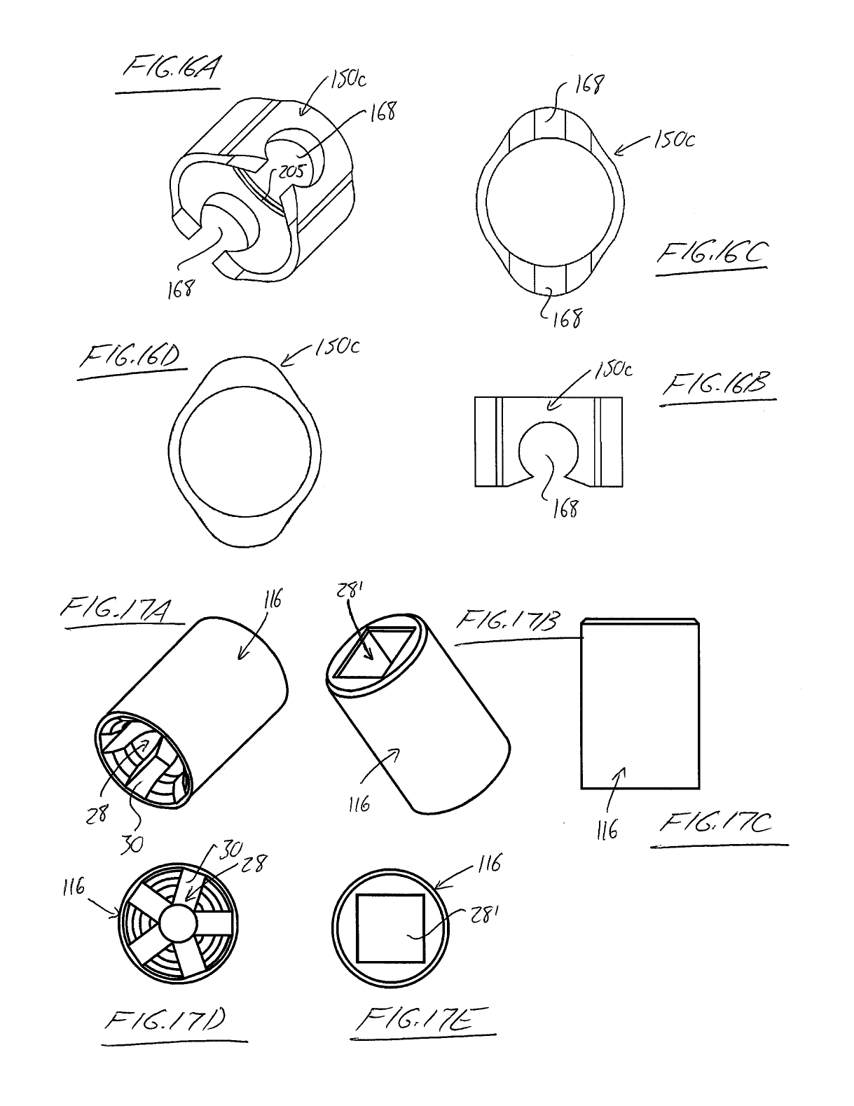

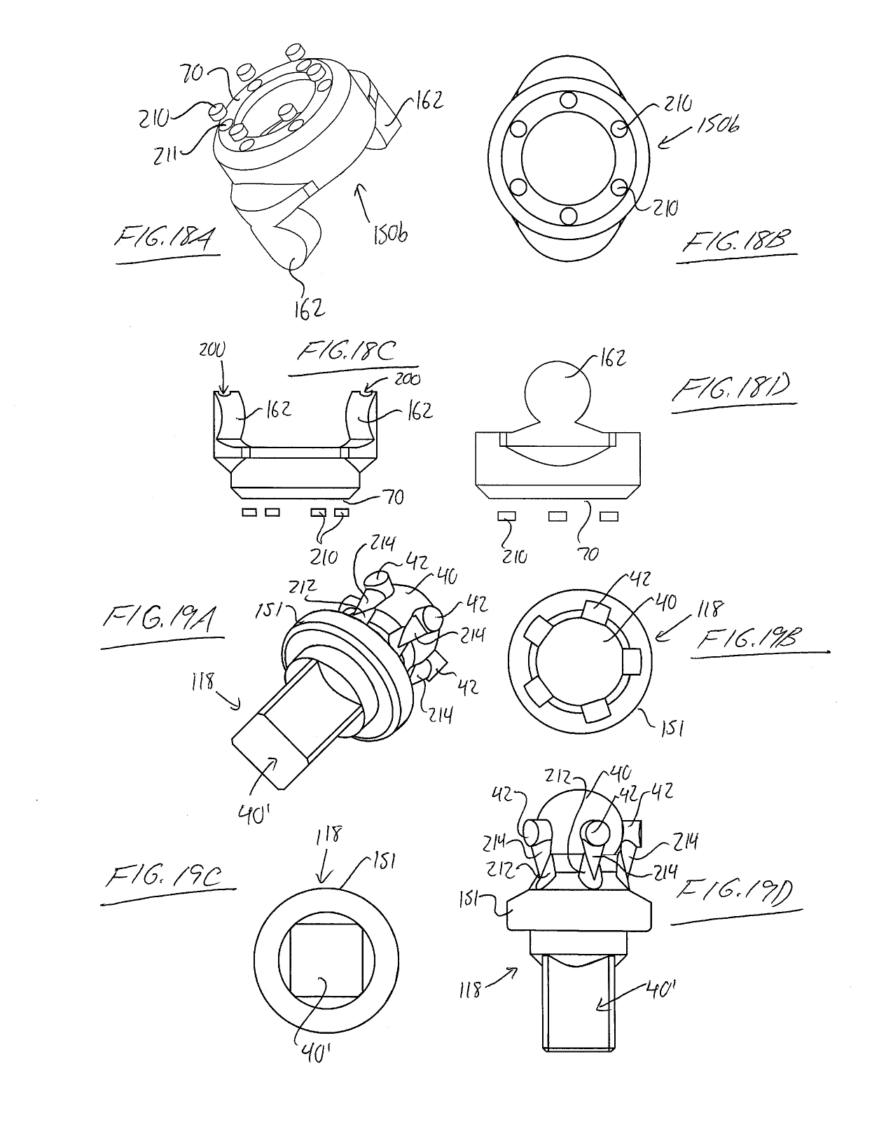

As shown in FIG. 16A, an annular groove 205 is provided in the cylindrical wall of the internal bore of the modified link body 150c near the end of this link body that lies opposite the unmodified link body 150d. As shown in FIG. 12B, a snap ring 206 is received in the groove adjacent the end of the casing marked by this end of the modified link body 150c. The inner diameter of the snap ring 206 is less than the outer diameter of the internal drive end adapter (not shown), but greater than the diagonal of the rectangular drive opening of the internal drive end adapter. As a result, the drive stud of a socket wrench or impact gun can be inserted through the opening of the snap ring 206 in order to drive the internal flexible shaft. At the same time, the snap ring retains the internal flexible shaft within the casing in order to prevent sliding of the shaft out of the ring-equipped end of the casing. The snap ring however can be easily removed by a user in order to allow withdrawal of the internal components from the casing for inspection, cleaning, repair or replacement. The modified link body 150c features no channels 200 like those found in the intermediate links 150 and the matching unmodified link body 150d of the drive end adapter 150a.

The working-end link 150b of the third embodiment casing 112 is like a truncated version of an intermediate link 150 that lacks the female recesses 168, and instead has a stop flange 70 similar the working end link 50b of the second embodiment in order to block sliding of the inner flexible shaft out of the respective end of the casing 112. The working end link 150b features a pair of modified channels 200a that are closed off at the narrower end thereof, but are otherwise the same as the axial channels 200 of the intermediate casing links 150. The modified channels 200a thus open into the working-end link 150b at the distal ends of the male ears 162 thereof. The working-end link 150b may employ a snap ring, like that of the drive end link 150a, instead of the stop flange 70. However, embodiments featuring only one removable snap ring reduce the number of separable parts, thereby minimizing the potential loss of same.

The third embodiment features a reversal of the link orientations relative to the second embodiment in that the drive end link 150a has no male feature (ears or lugs), the working end link 150b has no female feature (recesses or pin holes), and the male features of the links (ears or lugs) project or point toward the drive end of the assembled unit instead of the working end thereof. To match this change while still positioning the female socket end of each intermediate internal coupler in the appropriate position crossed by the pivot axis of the respective casing link, the third embodiment features a double male-ended working adapter 120 and a double female-ended driven end adapter. The double male-ended working adapter features a male drive stud 40′ projecting from the opening of the stop flange 70 of the working end link 150b and a male neck and ball combination 38, 40 extending from inside the truncated collar of the working end link 150b into the adjacent one of the intermediate links 150. An enlarged central shoulder 151 is defined on the working end adapter between the drive stud 40′ thereof and the neck 38 on which the ball 40 is carried. This shoulder 151 has an outer diameter greater in size than the inner diameter of the stop flange 70, whereby sliding of the working end adapter 120 out from the casing is prevented by the stop flange 70. The double female-ended drive adapter 116 features a rectangular drive opening 28′ inside the bore of the modified drive link body 150c of the drive-end link 150a and a female socket and slot combination 28, 30 inside the bore of the unmodified drive body 150d of the drive-end link 150a. The outer periphery of the drive-end adapter 116 in the third embodiment is uniformly cylindrical over the full length of the piece, and thus occupies the cylindrical through-bores of both the modified and unmodified link bodies of the drive-end link 150a.

As shown in FIG. 12C, a respective ductile wire 208 of bendable but shape-retaining form is received in each one of the stiffener-receiving passages on the two sides of the resulting casing 112 so as to extend fully through the tapered axial channel 200 of each intermediate link 150 on the respective side thereof, and reach into the closed-ended channels of the drive-end and working-end links 150a, 150b. The shape-maintaining functionality of the ductile wire 208 provides a degree of stiffness to the casing 112 by resisting relative pivoting between each pair of adjacent pivotally-coupled casing links 150, 150a, 150b. On the other hand, the bendability of the wire 208 still allows such pivoting of the casing links under application of sufficient manual force to allow manipulation of the casing into the desired shape for a particular task. Accordingly, this provides a tendency for the casing to maintain the selected shape into which it is manipulated by the user, and thus prevent or reduce the occurrence of a flailing action of the casing under driven rotation of the internal flexible shaft. The widened ends 204 of the tapered channels 200 accommodate passage of the ductile wire 208 from one casing link to the next without kinking of the wire despite the various pivotal positions in which these adjacent links may find themselves at any given time. On the other hand, close conformity of the narrower end 202 of each tapered channel 200 to the outer diameter of the ductile wire 208 acts to impart the stiffening or shape-retaining functionality to the casing by blocking radial movement between the link 150 and the ductile wire 208 at the constricted points of the stiffener-receiving passage defined by these narrow ends 202 of the communicating axial channels 200 that collectively form this passage.

One end 154 of the collar of the working-end link 150b and each intermediate link 150 of the casing is planar, except at the diametrically opposed locations from which the male ears 162 project axially from this otherwise planar end. The collar has a greater wall thickness at the diametrically opposed areas of its circumference where the male ears 162 and female recesses 168 are defined than elsewhere around the circumference so as to accommodate axial channels 200 of sufficient depth (measured radially in relation to the central axis of the cylindrical through-bore of the collar) that exceeds the ductile wire's outer diameter. The non-uniform wall thickness of the collar balances this need to accommodate the channel depth with the desire for material and weight efficiency by not using this greater wall thickness around the full circumference of the collar. The resulting thinner wall thickness between the two areas at which the ears 162 and recesses 168 of the link 150 are defined means that the link is somewhat more oblong in shape than round. The link thus has a greater outer diameter D1 (FIG. 12B) in a plane that contains both the pivot axis and bore axis of the link than in a plane of the bore axis that is perpendicular to the pivot axis (see D2, FIG. 12C).

A plurality of small magnets 210 may be inset into the stop flange 70 of the working-end link 150b of the casing 112 at spaced apart positions disposed circumferentially around the opening of the stop flange 70 through which the drive stud 40′ of the working end adapter 120 extends. The magnets 210 exert a magnetic attraction force at this end of the tool extension, thereby acting to draw the end face of a wrench socket against this working end face of the casing 112 and thereby retain the wrench socket in a suitable working position with its rectangular drive opening fully engaged over the rectangular drive stud 40′ of the flexible shaft that is rotatably driven from the opposing drive end of the tool extension. The magnets may be embedded within the material of the working-end link 150b, or inset into recessed areas 211 of the link and then adhesively secured in place or capped off with a suitable plug that prevents sliding of the magnets out of their respective seats recessed in the end face of the link 150b. Alternatively, magnets may be similarly incorporated into the internal working-end adapter 120 of the tool extension. In either case, the magnets are supported in positions situated radially outward of the drive stud 40′ at spaced positions around the axis thereof at or near a proximal end of the drive stud that is situated nearest to the intermediate internal coupler to which the working-end adapter 120 is coupled inside the casing 112. The magnets exert an attraction force that acts to draw the socket further onto the drive stud 40′, toward the proximal end thereof, from the opposing distal end 40a thereof onto which the drive opening of socket is slid by the user during preparation of the tool extension for use.

While the illustrated embodiment is described as having multiple magnets spaced circumferentially apart around the working end of the tool extension, embodiments with as little as one magnet may still provide a notable socket-retaining functionality. Where multiple inset magnets are used, they may be seated in respective individual recesses or cavities, or seated within a common annular recess extending around the axis of the drive stud 40′ of the working-end adapter 120 of the tool extension.

The intermediate internal couplers 118 of the third embodiment are very similar to those of the other embodiments, but featuring the addition of a set of bulbous protrusions 212 on the neck 38 of the piece that each reside at an angular position around the central longitudinal axis of the piece that matches a respective one of the pin-shaped projections 42 on the ball-shaped male end 40 of the coupler 118. A rib- or gusset-like reinforcement 214 runs axially along the piece from each protrusion 212 to the respective projection 42 and tapers in radial measurement in a direction moving axially from the pin 42 to the protrusion so that the radially-larger end of the reinforcement underlies nearly the full radial reach of the pin, while the narrower end of the reinforcement 214 integrally connects to the respective neck-protrusion 212 at a radial distance inward from the distal ends of the projections 42. The reinforcement of the projections by the radial enlargements defined by the protrusions and gusset ribs that integrally join the projections to the neck 38 at radial areas beyond the peripheral remainder of the neck 38 and ball 40 that remains between these reinforced areas decreases the risk of any projection fracturing from off the ball 40 of the coupler during use of the flexible extension.

The third embodiment is assembled by, starting with the working-end link 150b, sliding adjacent casing links laterally together on their pivot axes in order to slide the male ears 162 of one link into the corresponding female recesses of the next link. This assembly of casing links is repeated up to, and including, the unmodified link body 150d of the drive-end link 150a. At this point, with the casing links positioned in alignment with one another, the ductile wires are inserted into the aligned channels and bores of the assembled casing links, and the casing is then completed by the addition of the modified link body 150c of the drive-end link 150a, which closes off the channels of the unmodified link body 150d of the drive-end link so as to retain the ductile wires in their installed conditions within their respective passages on the opposing sides of the casing. With the casing links still (or again) positioned in alignment with one another (i.e. with their longitudinal axes aligned), the series of internal couplers and adapters (starting from the working-end adapter) are inserted into the aligned cylindrical bores of the casing links. Once installation of the full series of internal components has been completed by the insertion of the drive-end adapter 116, the final step of assembling the tool extension is the engagement of the snap-ring 206 into the internal groove 205 of the drive-end adapter, thereby securing the internal couplers and adapters within the casing. The installation of the ductile wires and internal couplers and adapters prevents the separation of the assembled casing links from one another, as lateral movement between each mating pair of the casing links (i.e. relative movement along their shared pivot axis) is prevented.

The second and third embodiments each provide a flexible extension for transmitting torque and impact from preferably a ratchet or impact wrench into difficult to reach areas, employing a group of ball-socket joints connected in a series featuring a female receiver for the tool at one end and a male coupler at the other end, all contained in casing that bends in a single plane. Used in this manner for transmitting rotational torque and impact from hand or power tools to hard to reach areas, this device can transmit large amounts of impact along with torque, whereas all other drives can only transfer torque with minimal impact beyond one joint. Very few prior art extensions made can effectively transfer any substantial amount of torque through a multitude of joints let alone withstand high torque and high impact. The second embodiment of the present invention has much greater stability, durability, flexibility and effectiveness then other tools within similar categories. Another unique trait incorporated into this device is the ease of manufacturing, assembly, serviceability and the ability for the inner and outer couplers to mesh in such a way that it generates little forces on the outer links and needs no other pieces incorporated within it to keep the rotating internal parts in their respective positions.

It is preferred that this tool be used with a hand ratchet or impact wrench to tighten and loosen fasteners in difficult areas, although it may be used for other purposes. It can be assembled to different lengths and can preferably provide a bending radius of roughly twice the diameter of the inner coupler. For example, the inner rotating coupler in a ½-inch drive is roughly 1-inch in diameter, roughly resulting in a bending radius of the tool 2 inches. This allows the tool to weave around obstacles to reach difficult areas, which saves a large amount of time and possible disassembly to gain access to the fastener.

The combination of the casing/housing and the rotating internal shaft formed by the jointed couplers creates a unique, extremely durable drive which self aligns, self stabilizes, causing it to run smoother and much safer when in operation. The pivot points of the rotating couplers have a direct relationship to the placement of the pivot points of the casing, causing the free floating couplers to align them selves within the casing. The simplistic nature of the tool creates an ease of manufacturing, assembly, service and repair. This tool can be connected in union with additional extensions and other conventional tools to reach increasingly difficult areas and still be safe and effective.

The limitations of the extension are defined by the limitations of the proper tools used to provide the driving force into the extension. The extension is not limited in operation by extreme conditions (hot, cold, wet, dry). Working models have shown that even with poor materials, this tool's operation is not compromised, instead only suffering in terms of its lifespan and the amount of energy able to be transmitted before failure. The poorest result in operation during testing came from filling the tool with a foreign material, resulting in a stiff operation until the rotating parts self-cleared the material out of the running area inside the casing. There is no real danger with operation, in that the tool does not kink or snake like conventional flexible drives.

In U.S. Patent Application Publication 2011/0303053, the male end is a hexagon shaped ball, which is fitted in a matching shaped female socket. The hexagon shaped drive creates a large amount of outward force on the female socket, creating increased wear and possible fracture of the socket. A small amount of wear creates a large amount of free movement within the joint, decreasing life and torque able to be applied. If used with a drive that delivers an impact this shape of drive will be expected to eventually fail. The retainers used to hold the joints in series do not prohibit the tool from buckling causing large loss of rotation and torque, furthermore being the casing spins with the joints all stability is lost.

The present solution to the hexagon ball-socket has been to utilize a pin system on the ball, and a slot system inside the socket. This system creates no outward force on the socket, allowing for less overall wear. Additional torque can be applied, providing the ability to handle high impact/high torque applications. This system also allows for a much longer life of the tool since a small amount of wear does not create large amount of free movement within the joint. The second and third embodiments utilize a casing that flexes in a single plane, creating a stable platform for all the joints to self align and self stabilize with no individual retaining rings. Being that the joints spin within the casing and self align, this eliminates all alignment and knuckling issues.

U.S. Pat. No. 6,152,726 features a ball-socket style joint. The male end is created with three objects protruding allowing that to fit into a female socket with matching slots. A retainer ring is used to hold the two couplers together. The two assembled couplers have one end made for a drive to be attached and the other made with the ability to attach to a fastener. This style of joint allows for torque and impact to be transferred through the two couplers effectively. Increasing the amount of couplers in series however would be expected to create stability issues causing one coupler to fold in on another. This issue eliminates all possibility of the tool transmitting torque or impact. The joints, as they are, may create issues with catching fingers in the bends since there is nothing to stabilize and control the lateral movement of the couplers. With use of three pins being favoured, it also creates unneeded outward pressure on the retainer causing the loss of energy and possible failure of said retainer.

The present solutions to the problems that arise from this prior art system are the use of a casing that flexes in a single plane to eliminate the stability issues, whether only two couplers are used or many more connected in a longer series. With this casing there is no need for a retainer ring at each joint since the design allows for the rotating inner couplers to align them selves with the outer non-rotating couplers while in operation. This also controls all unwanted lateral movement eliminating all snaking, knuckling and stability issues.

French Patent 2681919 teaches a device for efficiently transferring torque through a flexible drive shaft. This device is designed for use as a flexible drive for transferring constant rotating torque from a motor to a propulsion device (Boat, car, etc.) The design of this device will transfer torque very efficiently for a flexible drive but will not stand up to impact due to its use of a double cardian joint, along with the bearing involved in its operation. The casing that flexes in a single plane allows for stable transfer of torque, but the complex design of the rest of the drive creates difficulties in other areas of operation (manufacturing, repair and servicing). This drive system is acceptable for the application it was designed for, but would not be expected to stand up or work properly in some other applications.

The extension proposed herein in the second and third embodiments uses a casing with different rotating parts to allow for different types of workloads and abuse. Unlike in the prior art, the design of the second embodiment outer casing in the present invention has a direct relationship to the design and placing of the internal rotating parts. This allows the tool to transfer considerable impact as well as the required torque applied. Using ball-socket style couplers inside the casing creates a unique situation where it allows for the inner joints to free float within the casing. The position of the pivot points on the outer non-spinning couplers in relation to the pivot points of the inner spinning couplers causes the inner couplers to self align and self stabilize. This system is able to transfer considerable impact along with torque. This creates a more effective tool for removing fasteners (bolts, nuts, etc.) The simplistic nature and symbiotic relationship contained within the parts of this tool substantially lowers the chance of failure, simplifies assembly, manufacturing, maintenance and repair. This design allows for the casing to be a stable platform for the inner couplers, and the inner couplers fit within the casing so that they self align, free float and need no retainers or fastened connections between each inner coupler.

In summary of the second and third embodiments, the relationship between a casing that bends in a single plane and the ball and socket joint creates its own unique tool. To the best of the applicant's knowledge, there has not been a tool that has been able to provide the same capabilities, and furthermore this tool has been designed with simplicity in mind for exceptional operation, ease of manufacturing and the ability for anyone to disassemble and repair, service or replace parts when needed. It can properly function in many extreme environments, such as underwater or in extreme temperatures below melting point of the constructed material, and can use any of a number of different lubricant's, or be used with no lubricant. More then one extension can be connected together in series and they will function as one, even if each extension is bending in a separate plane.

It will be appreciated that many alternate embodiments are contemplated within the scope of the present invention. For example, while the internal couplers of the illustrated embodiments employ five projections 42, the number of projections may be reduced to as few as one, or increased beyond five, and while the illustrated projections are of cylindrical form with circular cross-sections, any of a number of projection shapes may be employed, including other rounded or curved shapes (e.g. oval, ellipse) and flat sided polygonal shapes (rectangle, hexagon, octagon, triangle, pentagon).

Although the illustrated embodiments feature outwardly extruding projections on the male portion and outwardly recessed slots in the female portion, it may be possible for other embodiments to have inwardly jutting projections on the walls of the female portion and inwardly recessed slots in the exterior of the male portion.

Prototypes of the first embodiment of the invention have featured internal components machined from metal. Initial prototypes of the second and third embodiments have been produced from plastic using three dimensional printing processes. However, other embodiments include the use of molding or casting techniques, and possible use of materials other than metals or plastics. Although the invention is described herein in terms of providing an extension between a socket and a socket wrench or impact gun, it will be appreciated that the unique couplers and housing of the present invention may likewise be employed to define flexible extensions for other torque-transmitting tools, or to provide flexible shafts for other applications.

The casing links illustrated for the second and third embodiments each feature a one-piece unitary construction in which the collar and mating male/female pivot joint features (lugs, flats and pins; or rounded ears and recesses) are all seamlessly-joined integral features of a unitary body of material. However, it will be appreciated that the same structure may be formed in another manner, for example by welding or other fastening together of initially separate components to form the resulting piece. For example, the illustrated second embodiment casing is based on plastic prototypes where there is sufficient resilient flexibility in the lugs to temporarily deflect them far enough apart to move the lug pins/posts over the rear end of the next link to insert the pins/posts into the radial holes of the next link under release of the lugs from this temporarily spread-apart state, thereby providing a snap-fit mode of assembly. However, embodiments in which lugs of metal or other more rigid material are not capable of such a snap-fit type assembly, may lack integral post pins for the pivotal connections, for example instead having holes in both the rear of the collar and lugs of the collar so that the holes can be aligned for subsequent insertion of a pin therein and fixing of said pin to the lug to achieve the same resulting pivotal connection.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A flexible transmission device comprising:
a series of internal couplers connected together end to end by ball and socket joints each formed by mating ball and socket ends of an adjacent pair of internal couplers in said series, the ball and socket joints being constrained against relative rotation between each adjacent pair of internal couplers in said series about a respective longitudinal axis of each internal coupler in said pair such that the ball and socket joint will allow relative tilting between said longitudinal axes while also enabling driven rotation of one internal coupler of said pair about the longitudinal axis thereof under rotation of the other internal coupler of said pair about the longitudinal axis thereof; and
an outer casing comprising a series of outer links each comprising a collar disposed about a respective one of the internal couplers to support said internal coupler at least partially inside a cylindrical axial through-bore of the collar in a manner concentrically rotatable therein, with each adjacent pair of the links being connected together by a pivotal connection enabling relative pivoting between said pair of links about a pivot axis that lies on a diameter line of a respective one of the through-bores of said adjacent pair of links and passes through a respective one of the ball and socket joints between the internal couplers;
wherein each internal coupler is rotatable relative to the link in which the internal coupler is at least partially received about a longitudinal axis of the bore of said link to enable rotation of the series of internal couplers as a flexible shaft inside the outer casing; and
wherein the internal couplers are free floating within the cylindrical axial through-bores of the outer casing with axial play present among the internal couplers, the axial playing being limited to an amount sufficiently small to prevent separation between the male and female ends of the intermediate couplers.

2. The flexible transmission device of claim 1 wherein the pivot axes of the pivotal connections between the links of the outer casing are all parallel with one another.

3. The flexible transmission device of claim 1 wherein the series of outer links of the casing comprises two end links defining opposing ends of the casing and a plurality of intermediate links connected between said two ends links, and the axial through bores of the intermediate links contain only the internal couplers.

4. The flexible transmission device of claim 1 wherein the series of outer links of the casing comprises two end links defining opposing ends of the casing and a plurality of intermediate links connected between said two ends links, and the axial through bores of the intermediate links are free of any components other than the internal couplers.

5. The flexible transmission device of claim 1 consisting only of said casing and said internal couplers.

6. The flexible transmission shaft of claim 5 wherein the casing further comprises one or more retaining rings to retain the series internal couplers within the casing, and wherein the one or more retaining rings are installed only at one or both of two opposing end links in the series of outer links.

7. The flexible transmission shaft of claim 6 wherein said one or more retaining rings consists of only one retaining ring installed at a respective one of the two opposing end links.

8. The flexible transmission device of claim 1 consisting only of said internal couplers and said links of said outer casing.

9. The flexible transmission device of claim 1 wherein the series of outer links of the casing comprises two end links defining opposing ends of the casing and a plurality of intermediate links connected between said two end links, the flexible transmission device consisting only of the series the internal couplers, the series of outer links, and a single retaining ring installed at one of said end links to keep the internal couplers inside the casing.

10. The flexible transmission device of claim 1 wherein the casing comprises at least one stiffening element running through the outer links at a location outside of the axial through bores of said series of outer links.

11. The flexible transmission device of claim 1 wherein:
the series of internal couplers includes a first-end internal coupler at a first end of said series, a second-end internal coupler at a second end of said series, and at least one intermediate internal coupler connected between said first-end internal coupler and said second-end internal coupler; said first-end internal coupler, said second-end internal coupler, and said at least one intermediate internal coupler having respective bodies each defining the respective longitudinal axis; the respective bodies of said at least one intermediate internal coupler and said first-end internal coupler each having a male end pointing in a first direction along the respective longitudinal axis, the respective bodies of said at least one intermediate internal coupler and said second-end internal coupler each having a female end pointing in an opposite second direction along the respective longitudinal axis, the male and female ends having opposing ones of at least one recessed slot having an axial length and a radial depth relative to the respective longitudinal axis and at least one projection having a radial extent relative to the respective longitudinal axis; the axial length of each slot exceeding a width of said slot, which exceeds a diameter of the projection, and each male end having been inserted into a hollow interior of a respective one of the female ends in an orientation sliding each projection into a respective slot in a fit that allows relative pivoting of the longitudinal axes of the series of internal couplers into and out of alignment with one another, whereby the series of internal couplers form the flexible shaft in which the relative pivoting of the longitudinal axes of the series of internal couplers allows flexible shape adjustment of the flexible shaft, while engagement of each projection with the respective slot enables transfer of torque from one of the first and second ends of the series of internal couplers to the other of the first and second ends of the series of internal couplers by rotation of either of the first-end internal coupler or the second-end internal coupler; and
the series of outer links includes a first end link, a second end link and at least one intermediate link connected between the first end link and the second end link, the respective collars of the at least one intermediate link and the second end link closing respectively around the respective bodies of the at least one intermediate internal coupler and the second-end internal coupler at portions of said bodies of said at least one intermediate internal coupler and said second-end internal coupler that surround the hollow interiors of the female ends of said bodies of said at least one intermediate internal coupler and said second-end internal coupler, and the pivotal axis of each pivotal connection crosses through the respective collar of the respective one of said adjacent pair of links and through the hollow interior of the female end of the respective body of the respective one of the series of internal couplers that is at least partially received in said respective collar of said respective one of said adjacent pair of links.

12. The flexible transmission device of claim 11 wherein each female end of the series of internal couplers has a boundary wall that surrounds the hollow interior of said female end and in which the at least one slot is formed, the axial length of the slot extends into the hollow interior of the body from the female end thereof, and each male end of the series of internal couplers features the at least one projection.

13. A flexible transmission device comprising:
a series of internal couplers connected together end to end by joints that are arranged to each allow relative tilting between longitudinal axes of a respective adjacent pair of said internal couplers while also enabling driven rotation of one internal coupler of said pair about the longitudinal axis thereof under rotation of the other internal coupler of said pair about the longitudinal axis thereof; and
an outer casing comprising a series of outer links having the internal couplers rotatably received within axial through bores of the outer links in a manner enabling rotation of the series of internal couplers as a flexible shaft inside the outer casing, the outer links being connected together in adjacent pairs by pivotal connections enabling relative pivoting between said links about pivot axes perpendicular to the longitudinal axes of the internal couplers; and
at least one elongated bendable shape-retaining stiffening element running through the outer links at a location outside of the axial through bores of said outer links to impart a shape-retaining tendency to the casing that resists relative pivoting between the outer links.

14. The flexible transmission device of claim 13 wherein the casing comprises an outer passage defined separately of the axial through bores by end-to-end communication of channels defined respectively in the series of the outer links, the stiffening element extending from channel to channel to span the series of the outer links in the resulting outer passage.

15. The flexible transmission device of claim 14 wherein the outer passage passes through the pivot axes of the pivotal connections provided between the outer links.

16. The flexible transmission device of claim 14 wherein the outer passage passes through mating male and female elements of the pivotal connections between the outer links.

17. The flexible transmission device of 16 wherein at each pivotal connection, a smaller end of one of the channels communicates with a larger end of a next one of the channels, the smaller end being narrower than the larger end in a plane normal to the pivot axes of the pivotal connections.

18. The flexible transmission device of 14 wherein the channels are each tapered to gradually widen from end to end in the plane normal to the pivot axes of the pivotal connections.

19. A flexible tool extension comprising:
a flexible transmission shaft comprising:
a series of couplers connected together end to end by joints that are each arranged to allow relative tilting between longitudinal axes of a respective adjacent pair of said internal couplers while also enabling driven rotation of one internal coupler of said pair about the longitudinal axis thereof under rotation of the other internal coupler of said pair about the longitudinal axis thereof;
a drive end adapter having a first end configured for engagement by a drive element of a tool, and a second end coupled to a first end coupler of the series of couplers at a first end of said series of couplers; and
a working end adapter having a first end with a drive stud shaped for receipt thereof in a mating drive opening of a wrench socket, and a second end coupled to a second end coupler of the series of couplers at a second end of said series of couplers; and
at least one magnet carried on the flexible transmission shaft adjacent a proximal end of the drive stud nearest the first end coupler at a location radially outward from an axis of the drive stud to provide a magnetic attraction force acting in a direction drawing the wrench socket toward the proximal end of the drive stud.

20. The flexible tool extension of claim 19 comprising an outer casing in which the flexible transmission shaft is rotatably disposed, wherein the at least one magnet is mounted to the outer casing at an area around an opening of the casing through which the working end adapter projects to expose a distal end of the drive stud outside of said casing for receipt of the wrench socket on said drive stud from the distal end thereof.
